(19) United States
(12) Patent Application Publication
(10) Pub. No.: US 2013/0182559 A1
(43) Pub. Date: Jul. 18, 2013

(54) TRANSMISSION NETWORK AND TRANSMISSION NETWORK MANAGEMENT SYSTEM

(71) Applicants: Shinya Fujioka, Kawasaki (JP); Yoshihiro Ashi, Yokohama (JP); Masahiko Mizutani, Fujisawa (JP); Hideki Endo, Kawasaki (JP)

(72) Inventors: Shinya Fujioka, Kawasaki (JP); Yoshihiro Ashi, Yokohama (JP); Masahiko Mizutani, Fujisawa (JP); Hideki Endo, Kawasaki (JP)

(73) Assignee: Hitachi, Ltd.

(21) Appl. No.: 13/553,631

(22) Filed: Jul. 19, 2012

(30) Foreign Application Priority Data
Aug. 26, 2011 (JP) 2011-184265

(51) Int. Cl. H04L 12/24

(52) U.S. Cl. CPC H04L 41/0668
USPC 370/218

(57) ABSTRACT

A transmission network is comprised of a network management system for collectively managing and controlling a plurality of transmission devices coupled mutually through transmission routes and the transmission network as well. The network management system includes a plane management table adapted to manage transmission planes defined as a set of paths in the transmission network, and the plane management table has the function to set and manage a transmission plane (working plane) applied during normal operation and besides, a single or a plurality of transmission planes (protection planes) applicable in the event of occurrence of a fault in the transmission network. Then, when a fault occurs in the transmission network, the network management system changes the applied plane to a suitable transmission plane.

### INCORPORATION BY REFERENCE

The present application claims priority from Japanese application JP2011-184265 filed on Aug. 26, 2011, the content of which is hereby incorporated by reference into this application.

### BACKGROUND OF THE INVENTION

The present invention relates to a transmission network and a transmission network management system and more particularly, to a transmission network in which when a fault takes place in a transmission device or a transmission route inside the transmission network, a process for switching over the route is carried out and, to a scheme for managing the transmission network as well.

Recently, as the amount of data to be transmitted has been increasing and information service using a network has been becoming diverse in a transmission network such as Internet and leased line, the transmission network has been required of compatibility between increase in capacity and assurance of reliability. One of factors indicative of the reliability the transmission network has is to suppress the influence upon service to minimum in the event that a fault takes place in the transmission device or transmission route inside the transmission network. Accordingly, many transmission networks are each implemented with a route control scheme adapted to execute transmission by using a route which bypasses a faulty spot in the event that a fault occurs.

Conventionally, the strategy for controlling a signal transmission path inside the transmission network is typified by a static path control scheme and a dynamic path control scheme.

In the static path control scheme, a signal is transmitted on a path which is predetermined by a network manager and this type of scheme has been used widely in the conventional synchronous transmission network. The static path control scheme adopts the path protection switchover function as a technique for reducing the influence during the occurrence of a fault. According to the aforementioned function, in addition to a normally used path (working path), a path (protection path) used as a bypass at the time of the occurrence of a fault is set in advance and when a fault takes place, switchover to the protection path is conducted at a high speed. In order for the switchover to the protection path to be carried out upon the occurrence of a fault on the working path, the occurrence of the fault on the path needs to be detected, and such detection can be materialized through constant monitoring of faulty paths pursuant to the conventional OAM (operation administration and maintenance) function.

The dynamic path control scheme in which each of the transmission devices searches and selects by itself a passable route is mainly used in an asynchronous packet transmission network such as an IP (Internet Protocol) network. In the dynamic path control scheme, when a path working at present becomes faulty and interrupted, the transmission device searches by itself a passable route to thereby select a bypass.

Further, a technique for materializing a rapid switchover in the event of the occurrence of a fault in the packet transmission network executing dynamic path control is described in JPA-S63-138848 (Patent Document 1). In the related art aiming at “Making a proper and quick recovery from a faulty status under control of a small-sized computer even when the network configuration becomes complicated or when such a change in configuration as extension is undertaken.”, accomplishment of the object can be realized by “1. A network fault management scheme for a network configuration having a network local manager and a network collective manager, wherein a network configuration table defining a network configuration is provided in the collective manager, and the local manager is checked for its status by using the network configuration table so as to detect a fault, and 2. A network fault management scheme as recited in 1 above, wherein when the result of the fault detection indicates the occurrence of a fault, the collective manager commands the local manager to execute switchover of lines and devices at a fault occurrence spot and at a configurationally related neighboring spot as well by designating time for switchover, so that the switchover can be carried out at the designated time.”

The related prior art is for conducting control and switchover in a unit of path but JP-A-2003-224587 (Patent Document 2) is for conducting control and switchover in a unit of network configuration. The related art has an object of “Providing a line relief method for improving the effect of relief by considering the importance of line when relieving a line on which a fault takes place in a network of mesh format, and providing a highly reliable network adopting the method.”, and the object is accomplished by “Lines are allotted with parameters in compliance with the degree of importance and in all of faulty cases, the importance is judged when carrying out relief. If a fault occurs on a line of high importance but no substitution therefor is present, a line of low degree of importance free from any fault is deleted and the line of high importance degree is allotted to the line spot for the sake of relief.”

### SUMMARY OF THE INVENTION

Most of the related arts are of a scheme for conducting control and switchover in a unit of path. In using the scheme, the path switchover process at the time of fault occurrence and the status after switchover as well are optimum for an individual path subject to a fault (partially optimum) but are not always optimum for the overall network (totally optimum). This point is exposed when a fault of large scale being affected by, for example, a disaster takes place.

For example, in the case of static path control, for the sake of preventing a bias and congestion of use bands from occurring in respect of individual paths after switchover of all switchover patterns has been conducted, network working which assumes the most sever one of presumable cases becomes necessary and consequently, utilization factor of network band will be degraded remarkably. Further, a path for which both a working path and a protection path become faulty is interrupted even when a different passable bypass exists.

The dynamic path control is said to be highly effective to deal with a fault in point of keeping continuity but it searches a bypass after the occurrence of the fault and is problematic in that it has no knowledge of the congestion condition and the efficiency of communication the bypass to be selected concerns. Consequently, in the course that the individual transmission devices search and select passable routes during the occurrence of a fault, congestion occurs even in normal routes, resulting in generation of switchover in wide range, and much time is consumed before completion of switchover and so, paths to be eventually selected will be biased or localized. Even using the technique described in Patent Document 1, calculation of a suitable network configuration must be conducted as necessarily at the time of fault occurrence and therefore, in the event of a large scale fault, much time is considered to be necessary especially for calculation. Further, guarantee against the pass localization and the presence of congestion as a result of changing the network configuration is not promised.

When using the technique described in Patent Document 2, switchover to an optimum network configuration can be materialized by conducing calculation of a proper network configuration with the fault conditions in mind. But, as the network configuration becomes complicated and time to calculate an optimum network configuration increases, there arises a problem that the time to switchover increases. Further, guaranteeing the normality of a path to be used after switchover is not referred to and when a route unused before switchover is used after the switchover, guaranteed normality of the route now in use is not promised.

In view of the above, it is an object of the present invention to provide a scheme which can materialize change of the overall network to a proper configuration steadily and speedily even in the event that a large scale fault takes place in the transmission network.

A transmission network is configured by using a network management system adapted to collectively manage and control not only a plurality of transmission devices connected mutually through transmission routes but also the transmission network. The network management system comprises a plane management table for managing a transmission plane defined by a set of transmission routes (paths) inside a transmission network, and the plane management table has the function to set and manage a transmission plane applicable during normal operation (working plane) and besides, a single or a plurality of transmission planes applicable in the event of occurrence of a fault inside the transmission network (protection plane). Then, at the time a fault occurs in the transmission network, the network management system instructs the individual transmission devices to change the applied plane to a proper transmission plane and to switch over the route of path to the path setting adapted for the plane after changing.

According to the present invention, when a fault takes place in the transmission network, a change of the overall network configuration to a proper configuration (plane switchover) can be executed steadily and speedily.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram illustrating an example of configuration of a transmission network described in embodiment 1 of the present invention.

FIG. 2 is a diagram illustrating an example of a path configuration on a working plane in transmission network 10 in FIG. 1.

FIG. 3 is a diagram illustrating an example of a path configuration on a first protection plane in transmission network 10 in FIG. 1.

FIG. 4 is a diagram illustrating an example of a path configuration on a second protection plane in transmission network 10 in FIG. 1.

FIG. 5 is a diagram illustrating an example of switchover operation at the time of the occurrence of a fault in the transmission network 10 in FIG. 1.

FIG. 6 illustrates an example of a functional block diagram of transmission device 110.

FIG. 7 illustrates an example of a functional block diagram of network management system 100.

FIG. 8 is a diagram showing an example of structure of a plane management table 1001 of network management system 100.

FIG. 9 is a diagram showing an example of status of the plane management table 1001 after the occurrence of a fault.

FIG. 10 is a diagram showing an example of status of the plane management table 1001 after completion of plane switchover.

FIG. 11 is a flowchart showing an example of processing in a network information management controller 1000 in network management system 100.

FIG. 12 is a diagram for explaining an example of switchover operation at the time of the occurrence of a fault in a transmission network described in connection with embodiment 2 of the present invention.

FIG. 13 illustrates an example of a functional block diagram of network management system 101.

FIG. 14 is a flowchart showing an example of processing in network information management controller 1010 in network management system 101.

FIG. 15 is a diagram illustrating an example of a path configuration on a working plane in transmission network 11 of FIG. 10.

FIG. 16 is a diagram illustrating an example of a path configuration on a first protection plane in transmission network 11 of FIG. 10.

FIG. 17 is a diagram illustrating an example of a path configuration on a working plane in transmission network described in connection with embodiment 3 of the present invention.

FIG. 18 is a diagram illustrating an example of switchover operation at the time of occurrence of a fault in the transmission network 12 of FIG. 17.

FIG. 19 illustrates an example of a functional block diagram of network management system 102.

FIG. 20 is a diagram showing an example of structure of a plane management table 1021 of network management system 102.

FIG. 21 is a flowchart showing an example of processing in a network information management controller 1010 of network management system 102.

### DESCRIPTION OF THE EMBODIMENTS

Embodiments of the present invention will now be described with reference to the accompanying drawings.

### 1. Embodiment 1

In the present embodiment, an example of a transmission network will be described in which a set of a plurality of transmission paths in a transmission network is managed in terms of a plane by means of a network management system and when a fault occurs on a working plane used normally, the working plane is switched to either a protection plane or the most proper one of a plurality of protection planes which are prepared in advance. In such an event that faults occur in a plurality of transmission devices and transmission routes within a range inside the transmission network and any of highly preferential paths of working paths and protection paths become interrupted under the conventional static path control and, as a result, a plurality of path switchovers are generated to give rise to generation of congestion and localization of paths inside the transmission network, switchover is conducted swiftly to a protection plane designed in advance on the assumption that such plural faults will occur to thereby ensure that a transmission path of high preference can be assured at its maximum and besides, changing to a network configuration devoid of congestion and localization of paths can be materialized by applying the transmission network in the form according to the present embodiment. Furthermore, in the present embodiment, even in operation proceeding on a working plane, conditions of all protection planes are monitored constantly and upon occurrence of a fault, a plane is selected on the basis of the results of monitoring of all planes, so that even when a transmission path unused before plane switchover is brought into use after the plane switchover, normality after the switchover can be guaranteed to advantage.

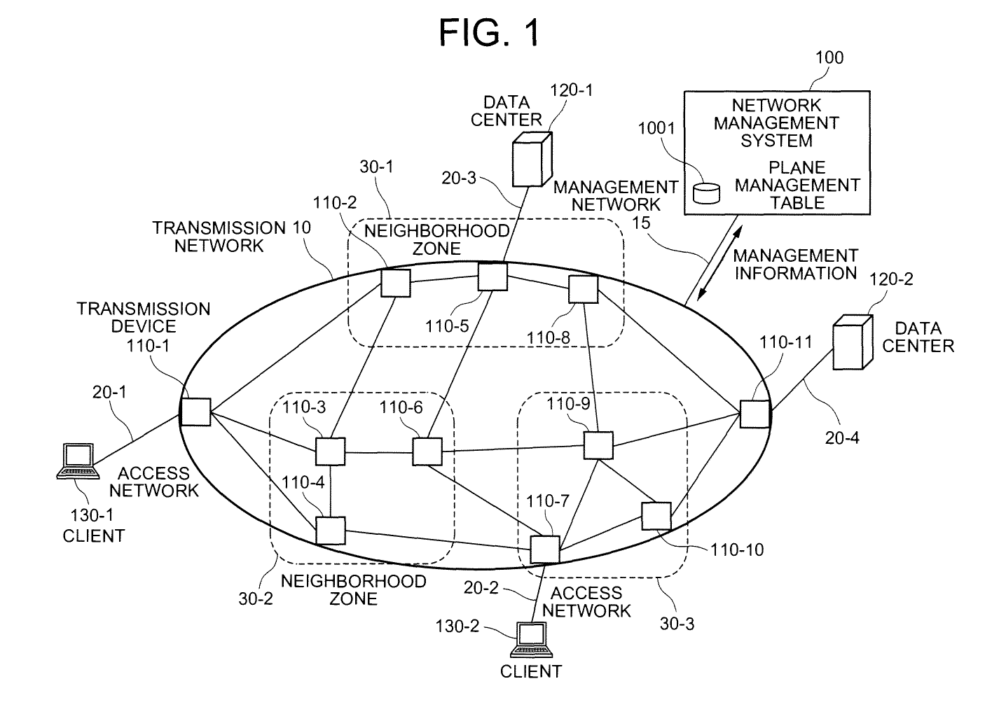

Referring now to FIG. 1, a transmission network 10 according to the present embodiment is configured as exemplified therein. In the configuration of transmission network 10, a plurality of transmission devices 110-1 to 110-11 are coupled mutually through the medium of transmission routes. The transmission network 10 is coupled to data centers 120-1 and 120-2 and client terminals 130-1 and 130-2 by way of access networks 20-1 to 20-4 so as to act as a transmission network for transmitting data between each of the data center and each of the client terminals with the help of each of the transmission devices 110.

Coupling of the data centers to the client terminals 130-1 and 130-2 is not limitative and the client terminal may be coupled with any server such as a contents server which distributes Web contents or a server which offers various applications and service. Further, the client terminals 130-1 and 130-2 may communicate with each other by way of the transmission network 10.

It should be understood that in a neighborhood zone 30-1, 30-2 or 30-3 indicated at dotted line, transmission devices 110 are located at geographically neighboring positions (for example, within a prefecture in Japan).

The transmission devices 110-1, 5, 7 and 11 are coupled with the access networks 20-1, 3, 2 and 4, respectively, to act as edges of transmission network 10 which will hereinafter be termed edge transmission devices.

Also, in the present embodiment, a route for interconnecting two transmission devices 110 adjacent to each other as described previously is called a transmission route. For the transmission route, an optical fiber of 10 gigabits Ethernet (registered trade name), for example, can be used in the present embodiment.

Then, a route from an edge transmission device to another edge transmission device is called a path. If the edge transmission devices are adjoining, the path may be formed of a single transmission route. But, if the edge transmission devices are remote from each other and one or more transmission devices 110 intervene therebetween, the path is constituted by a plurality of transmission routes.

In the present embodiment, as a transmission scheme of transmission network 10, a MPLS-TP (Multi Protocol Label Switching-Transport Profile), for example, can be used which is noticed as an asynchronous packet transmission scheme having transmission efficiency and high reliability for network. This scheme having extensity and transmission efficiency of the variable length packet transmission technique is added with features of the conventional synchronous transmission technique such as connection oriented static path control scheme, the function to detect faults on the basis of OAM and the QoS (Quality of Service) function of, for example, band control and preferential control and is standardized as a scheme capable of dealing with maintenance and working management equivalent to those by the synchronous transmission network in the variable length packet transmission network.

Also, in the present embodiment, as the transmission scheme of access network 20, an Ethernet (registered trade name held hereinafter) network and an ATM (Asynchronous Transfer Mode) network can be used.

Further, the transmission devices 110-1 to 110-11 are coupled to the network management system 100 by way of a management network 15 so as to inform the network management system 100 of management information indicative of, for example, a fault detection status inside the transmission network 10 and to receive management information such as path setting instructions from the network management system 100.

In the transmission network 10, faults are monitored in a unit of transmission device of a transmission route (a route between two adjoining transmission devices) and of a path (a route from an edge transmission device to another edge transmission device), and pieces of information are collected in the network management system 100.

The individual fault monitoring operations may be materialized by known technologies including monitoring a fault in the transmission device by means of its CPU (Central Processing Unit), monitoring input interruption and link-down of a link layer of an optical interface of transmission device coupled to the transmission route and path connection constant monitoring pursuant to MPLT-TP OAM being in process of standardization by IETF (Internet Engineering Task Force) and ITU-T (International Telecommunication Union-Telecommunication Standardization Sector) in cooperation. For the fault monitoring in a unit of path, either Ethernet OAM standardized in two frames of ITU-T Y. 1731 and IEEE 802.1ag or MPLS OAM standardized by ITU-TY. 1711 may be used.

The path inside the transmission network 10 is managed by the static path control scheme and is set to the individual transmission devices 110 from the network management system 100. In the present embodiment, a set of paths settable simultaneously inside the transmission network 10 and a pattern of combined paths are managed in terms of concept of a plane. Thus, the network management system 100 manages a plurality of planes assumed as a pattern of combination of paths which differs in accordance with spots where faults occur by using a plane management table 1001. In the transmission network 10, in addition to a plane used for transmission during normal operation (working plane), planes to be used at the time of failure of the working plane (protection plane) are set in advance and the working plane and the protection planes are monitored constantly. When a fault occurs, a path configuration change in a unit of plane (plane switchover) is carried out on the basis of a fault detection status on each of the planes.

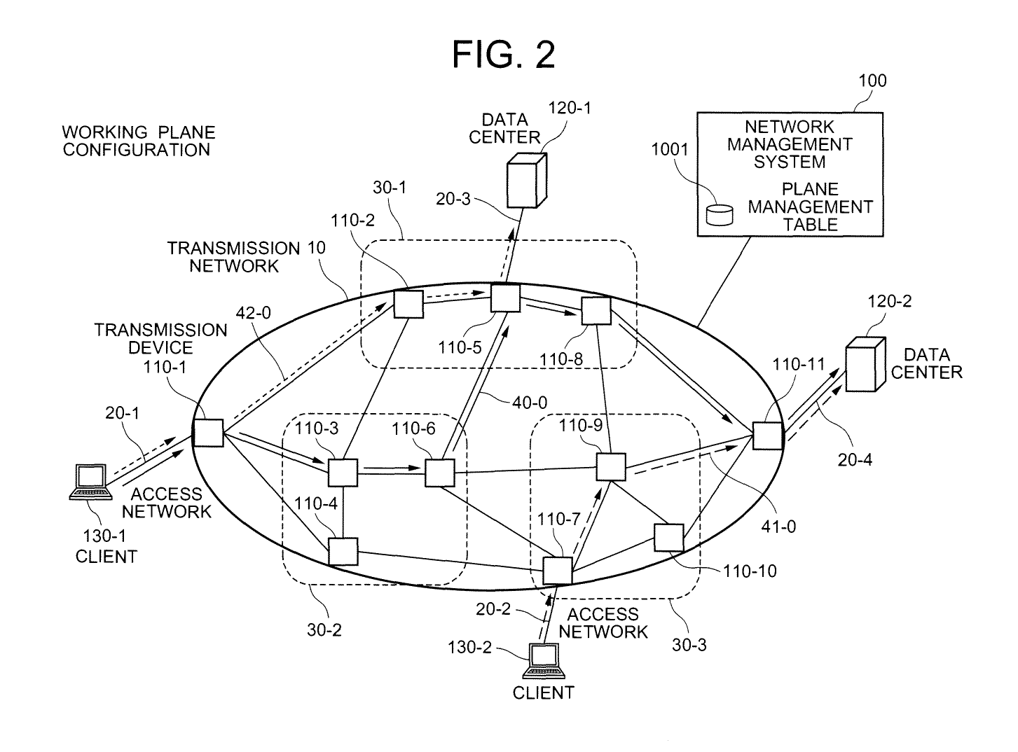

By making reference to FIGS. 2 to 11, a path configuration example on each plane and switchover operation will be described in greater detail.

Illustrated in FIG. 2 is an example of a path configuration on a working plane in the transmission network 10 of FIG. 1.

A path 40-0 indicated at solid line is a highly preferential path originating from an edge transmission device represented by transmission device 110-1 and terminating in an edge transmission device represented by transmission device 110-11 through relay points of transmission devices 110-3, 6, 5 and 8, having a guaranteed utilization band of 9 Gbps (giga-bits/second). A path 41-0 indicated at dashed line is a medium preference path originating from an edge transmission device represented by transmission device 110-7 and terminating in the edge transmission device represented by transmission device 110-11 through a relay point of transmission device 110-9, having a guaranteed utilization band of 5 Gbps. A path 42-0 indicated at dotted line is a low preference path extending from the edge transmission device represented by transmission device 110-1 to an edge transmission device represented by transmission device 110-5 through a relay point of transmission device 110-2, having a guaranteed utilization band of 2 Gbps.

The preferential degree of path designates the degree of preference for securing a route and a band at the time of occurrence of a fault and is set to each of the paths in advance. In the drawing, the path is expressed by a unidirectional arrow for the sake of convenience but actual data may be transmitted in any of unidirectional direction and bidirectional direction (This holds in the following figures.)

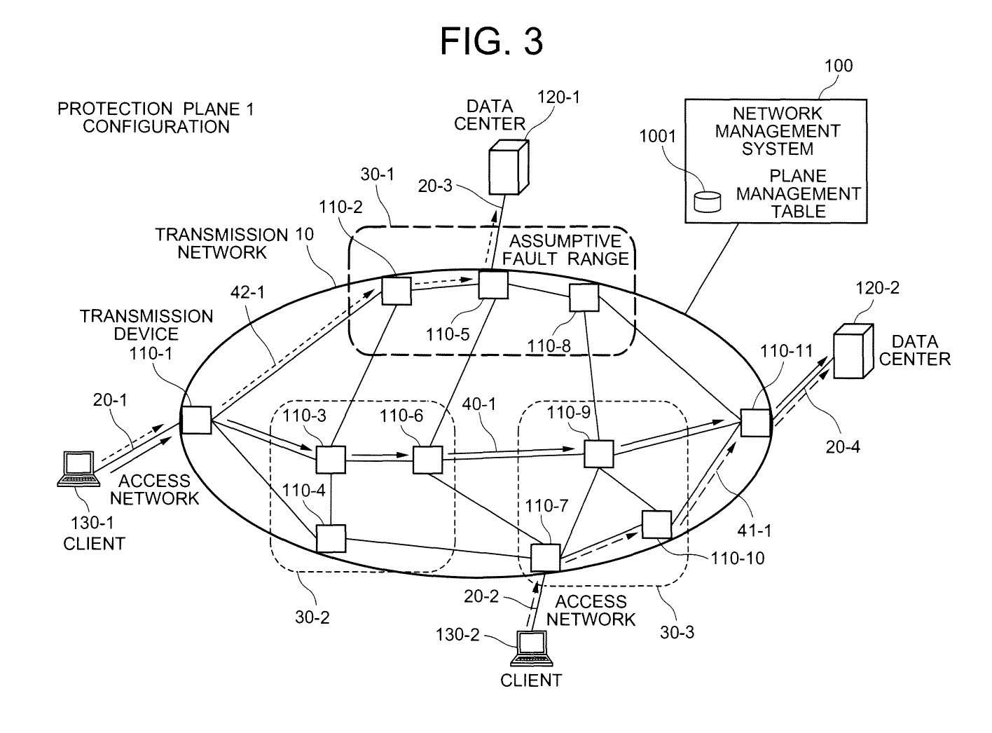

Illustrated in FIG. 3 is an example of a path configuration on a first protection plane to be used in the transmission network 10 of FIG. 1. In the present embodiment, in consideration of the fact that faults will be liable to occur simultaneously in the transmission devices and transmission routes constituting the transmission network inside a zone in the event of a natural calamity such as an earthquake, a path configuration on protection plane optimal for transmission networks in zones excepting the fault occurrence range is designed by presuming that faults will occur in the transmission devices or transmission routes in a single or plural ones of the neighborhood zones 30-1 to 30-3 in the transmission network. The optimal path configuration referred to herein means a path configuration which can preferentially secure a passable bypass in a transmission network excepting that in the fault occurrence range and can also secure the transmission band in association with the highly preferential path 40 and subsequently, can secure a passable bypass and transmission band for the medium preference path 41 and thereafter can secure a passable bypass and transmission band for the low preferential path 42, in order that transmission can be permitted as far as possible through transmission routes unoccupied at individual timing points.

The first protection plane illustrated in FIG. 3 is designed by using the neighborhood zone 30-1 as an assumptive faulty range. A path 40-1 is a protection system path of highly preferential path 40-0, having relay points of transmission devices 110-3, 6 and 9. A path 41-1 is designed as a protection system path of intermediate preference path 41-0, having a relay point of transmission device 110-10. A path 42-1 is designed as a protection system path of low preference path 42-0 but the edge transmission device 110-5 in the path is included in the assumptive faulty range and so, transmission through this path is impossible even by using a bypass. To deal with such a case, a path similar to the path 42-0 is set in FIG. 3.

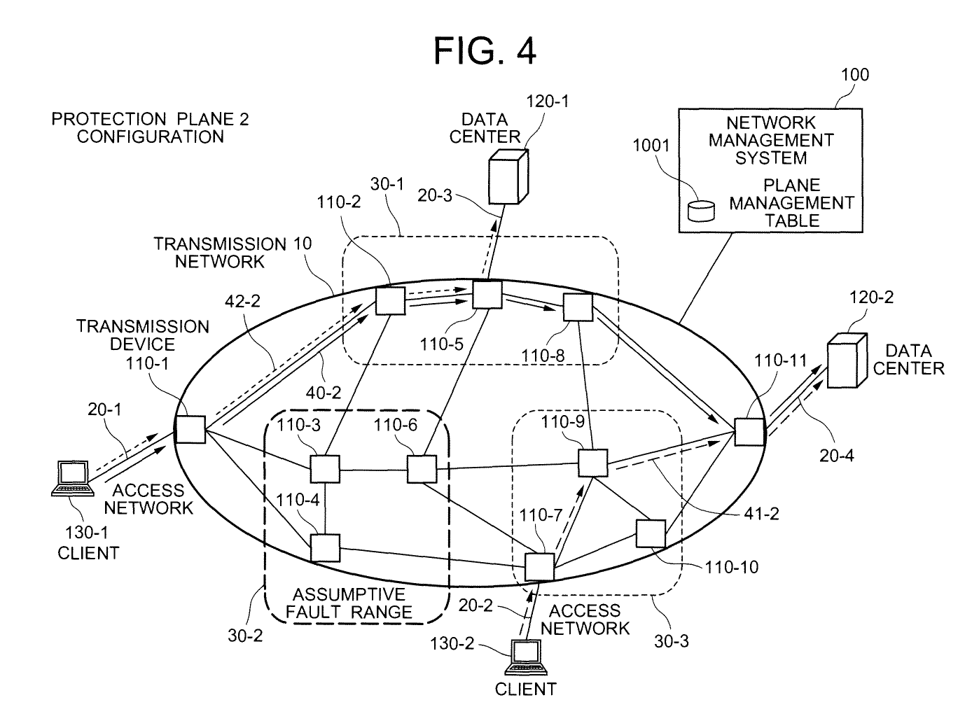

Illustrated in FIG. 4 is an example of a path configuration on a second protection plane to be used in the transmission network 10 of FIG. 1. The second protection plane is designed by presuming the neighborhood zone 30-2 as an assumptive faulty range. Paths 40-2, 41-2 and 42-2 are designed as protection systems of high preference path 40-0, medium preference path 41-0 and low preference path 42-0, respectively. To add, both the high preference path 40 and low preference path 42 must route through the transmission devices 110-1, 2 and 5 but in the present embodiment, the transmission band the single transmission route can use is 10 Gbps and therefore, in accordance with the preferential degrees, 9 Gbps and 1 Gbps guaranteed bands are set to the high preference path 40-2 and low preference path 42-2, respectively.

In the present embodiment, the two examples of protection plane design are described in which the assumptive faulty range in FIG. 3 differs from that in FIG. 4. By setting more protection planes based on a similar design rule, changes of network configuration conforming to generation of faults in various ranges inside the transmission network can be materialized. In the present embodiment, the protection plane is described as being designed in advance at the time that the network configuration is designed but by practicing design of a protection plane even after starting working of the transmission network and by adding setting to the network management system 100 and individual transmission devices at desired time, more faulty patterns can be dealt with to improve the reliability of the network continuously.

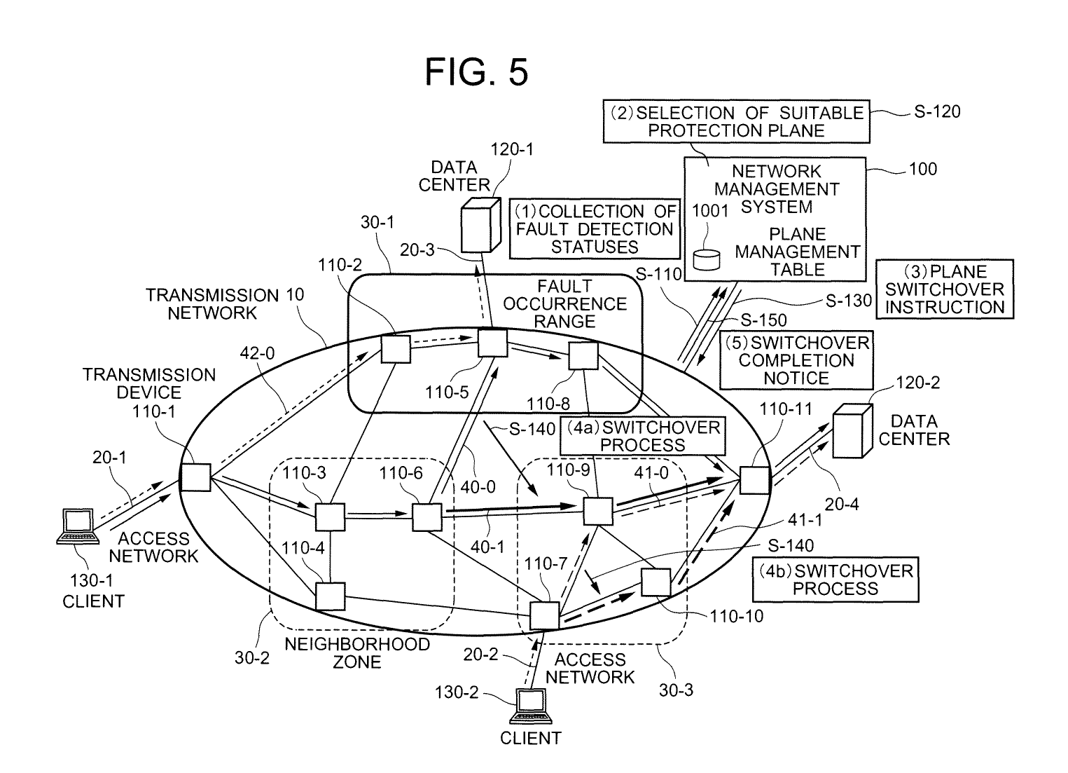

Turning to FIG. 5, there is illustrated an example of switchover operation when a fault takes place in the transmission network of FIG. 1. In this example, an operation will be described in which a fault occurs in the neighborhood zone 30-1 and the selection plane is changed from the working plane of FIG. 2 to the first protection plane of FIG. 3. In the present embodiment, fault monitoring is constantly carried out for not only paths on the working plane but also paths on the protection plane and a suitable plane is selected by using fault influence degrees calculated in respect of individual planes on the basis of fault detection information in a unit of path.

When a fault occurs in the neighborhood zone 30-1, the high preference path 40-0 and low preference path 42-0 on the working plane are interrupted and a transmission device though which these paths route detects a fault on the path by using the known OAM technique such as MPLS-TP or Ethernet to report it to the network management system 100 as indicated at S-110. The network management system 100 reflects the fault information upon the plane management table 1001 to perform calculation and comparison of fault influence degrees of the individual planes and on the basis of the results of calculation and comparison, selects the first protection plane as a suitable plane in this instance as indicated at S-120.

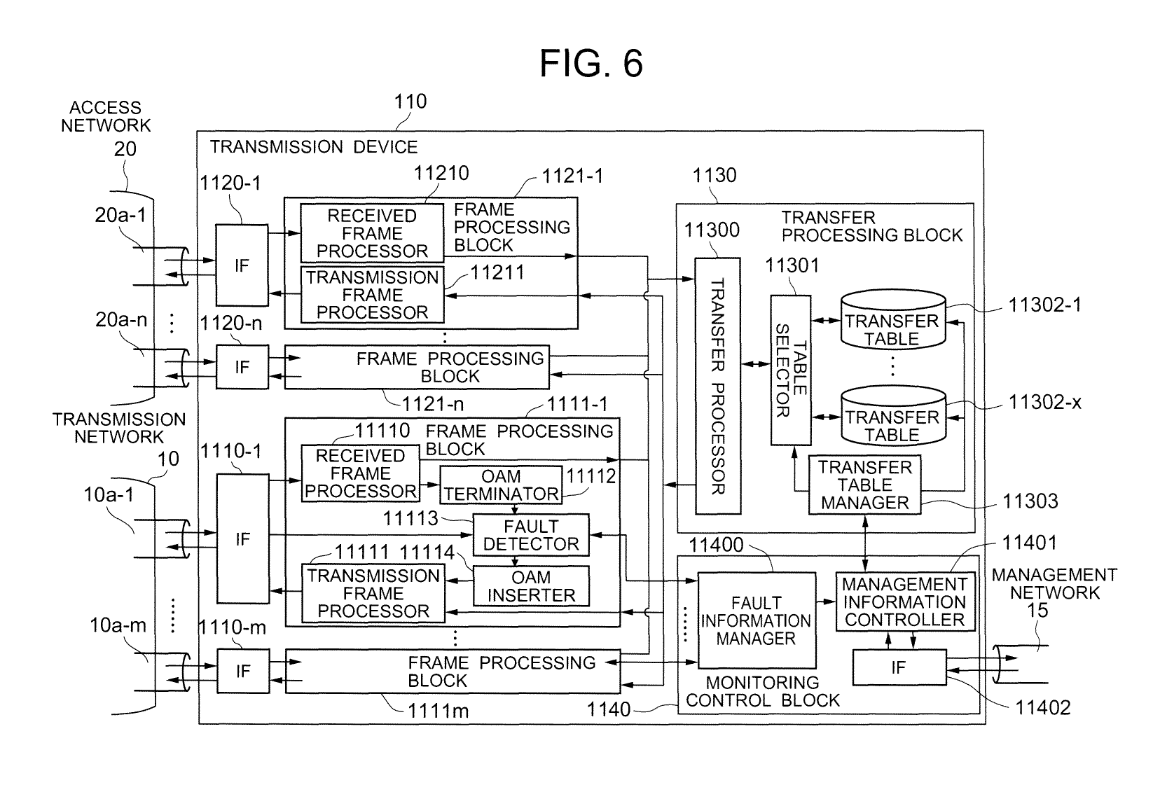

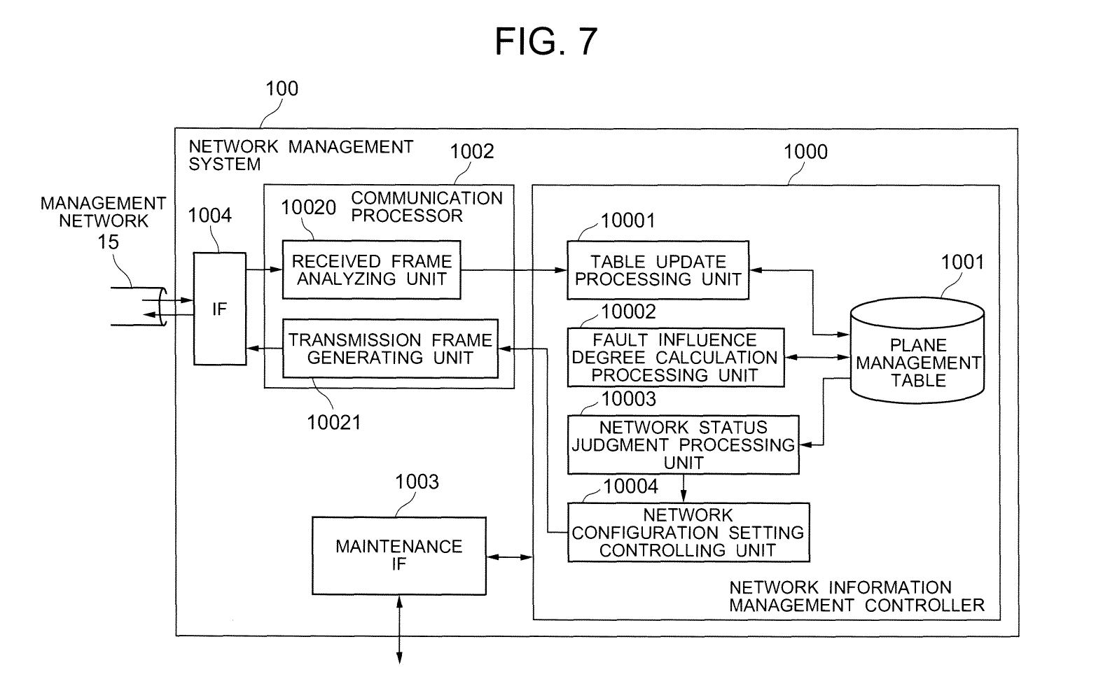

On the basis of the result of selection, the network management system 100 instructs the individual transmission devices 110 to change planes as indicated at S-130. In the case of this example, switchover from the working plane to the first protection plane is instructed. Each of the transmission devices 110 in receipt of the plane change instruction executes changing the selection plane on the basis of the instruction as indicated at S-140. The functional blocks of the transmission device 110 and network management system 100 for materializing the present operation will be described hereunder in greater detail by making reference to FIGS. 6 and 7.

In the present embodiment, pieces of setting information of the individual planes are shared by the network management system 100 and transmission device 110 and switchover is conducted on the basis of the instruction to change the plane. The setting information of individual planes the transmission device 110 holds is information which indicates, in response to identifiers of received frame and packet, for example, as to which transmission route these frame and packet are transmitted to on the plane selected at present, and corresponds to a transfer table 11302 to be described later.

Alternatively, setting information associated with a plane may be managed by only the network management system 100 and the switchover may be instructed when the network management system 100 is caused to issue a path setting change concomitant with the plane change to the individual transmission devices. In this case, the network management system 100 prepares, from path setting associated with the selected plane, an instruction concerning setting of a path to be instructed to the transmission device 110. In such an instance, the existing device can be used as the transmission device 110.

Turning now to FIG. 6, the edge transmission device 110 is illustrated in functional block diagram form. The transmission device 110 includes interfaces (hereinafter abbreviated as IF's) 1110-1 to 1110-m for transmission and reception as well of packets to and from transmission routes 10a-1 to 10a-m belonging to the transmission network 10 and IF's 1120-1 to 1120-n for transmission and reception as well of packets to and from transmission routes 20a-1 to 20a-n belonging to the access network 20. Frame processing blocks 1111-1 to 1111-m and frame processing blocks 1121-1 to 1121-n apply processes to be described later to frames received from the individual IF's and to frames transmitted to the individual IF's, so that the frames can be transferred by means of a transfer processing block 1130 to frame processing blocks connected to destination IF's of received frames. Also, by means of a monitoring control block 1140 coupled to the management network 15, communication of fault detection information and path setting information is executed. In the present embodiment, the individual frame processing blocks are connected to the individual IF's in one to one relation but the frame transmission and reception process to and from a plurality of IF's may structurally be conducted by means of a single frame processing block.

The individual frame processing blocks 1121-1 to 1121-n execute processes similar to each other and therefore, operation will be described by way of example of construction of one of them, that is, frame processing block 1121-1. The frame processing block 1121-1 includes a received frame processor 11210 and a transmission frame processor 11211. The received frame processor 11210 identifies an Ethernet frame and an ATM cell transmitted from the access network 20 and capsules them to a MPLS frame which in turn is transmitted to the transfer processing block 1130. The transmission frame processor 11211 receives a frame from the transfer processing block 1130, removes a MPLS header from it and transmits a resulting frame to the access network.

Each of the frame processing blocks 1111-1 to 1111-m is a block for performing a similar process and so, operation will be described by taking the construction of one of them, that is, the frame processing block 1111-1, for instance. The frame processing block 1111-1 includes a received frame processor 11110, a transmission frame processor 11111, an OAM terminator 11112, a fault detector 11113 and an OAM inserter 11114. The received frame processor 11110 identifies a MPLS frame transmitted from the transmission network 10 so that an OAM frame may be transferred to the OAM terminator 11112 and user data may be converted into a MPLS label as necessary and then transferred to the transfer processing block 1130. The OAM terminator 11112 judges, through the known method, the presence or absence of a fault in a unit of path on the basis of the received OAM frame and informs the fault detector 11113 of the result. Receiving from the OAM terminator 11112 information indicative of the fault in a unit of path and information indicative of physical link interruption from the IF 1110-1, the fault detector 11113 informs a monitoring control block 1140 of these pieces of information and as necessary, instructs the OAM inserter 11114 to transfer the fault information in the form of an OAM frame. The OAM inserter 11114 operates to constantly insert an OAM frame for monitoring continuity and as necessary, inserts an OAM frame for transferring the fault information and an OAM for testing. The transmission frame processor 11111 executes scheduling of user data from the transfer processing block 1130 and OAM frame from the OAM inserter 11114 and transfers them to the IF 1110-1.

The transfer processing block 1130 includes a transfer processor 11300. a table selector 11301, transfer tables 11302-1˜11302-x and a transfer table manager 11303. By consulting a transfer table 11302 selected by the table selector 11301 on the basis of label information of a MPLS frame received from each of the frame processing blocks, the transfer processor 11300 executes transfer of the frame to a frame processing block to be connected to a destination IF corresponding to label information.

Each of the transfer tables 11302-1 to 11302-x is a table for managing frame identification information such as MPLS label and destination IF information of a received frame by making correspondence to a path, and the individual transfer tables correspond to pieces of information on individual planes the network management system 100 manages. In other words, the transfer device 110 holds the transfer tables 11302 corresponding to setting of individual paths on each of the planes the network management system 100 sets. Then, by consulting a transfer table corresponding to a plane selected at present in response to instructions from the network management system 100, the table selector 11301 carries out setting of the transfer processor 11300.

The transfer table manager 11303 is a block for managing the table selector 11301 and transfer tables 11302-1 to 11302-x and by receiving management information reported by way of the management network 15 and monitoring control block 1140, executes change of selection by the table selector 11301 and addition/edition of the transfer table 11302.

The monitoring control block 1140 includes a fault information manager 11400, a management information controller 11401 and an IF 11402 coupled to the management network 15. The fault information manager 11400 collects pieces of fault detection information in a unit of path and in a unit of physical port reported from the frame processing block and pieces of fault detection information inside the device and informs the management information controller 11401 of these pieces of information and as necessary, instructs the fault detector in frame processing block to transfer pieces of fault information. The management information controller 11401 transfers the fault detection information reported from the fault information manager 11400 to the management network 15 via the IF 11402 and besides, reports management information indicative of plane switchover instruction and plane setting change from the management network 15 to the transfer processing block 1130.

In connection with FIG. 6, the functional block diagram of transmission device 110 is described by way of example of the construction of edge transmission device but in the case of a relay transmission device such as transmission device 110-2 coupled to only the transmission network 10, the IF 1120 coupled to the access network 20 and the frame processing block 1121 are unneeded.

Illustrated in FIG. 7 is a functional block diagram of the network management system 100. The network management system includes a network information management controller 1000, a communication processor 1002, a maintenance interface (hereinafter abbreviated as IF) 1003 and an IF 1004 coupled to the management network 15.

The communication processor 1002 has a received frame analyzing unit 10020 for analyzing a frame received from the transmission device 110 and transferring fault detection information and management information responsive to the plane switchover completion to the network information managing controller 1000, and a transmission frame generating unit 10021 responsive to a report from the network information management controller 1000 to generate plane switchover instructions and management information indicative of plane setting change and transmit them to the transmission device 110.

The network information management controller 1000 includes a plane management table 1001, a table update processing unit 10001, a fault influence degree calculating unit 10002, a network status judgment processing unit 10003 and a network configuration setting controlling unit 10004. The plane management table 1001 is a table adapted to store pieces of information of paths belonging to the individual planes and information indicative of fault detection status, and the network information management controller 1000 selects a suitable plane conforming to conditions of a fault on transmission network 10 by using the information in plane management table 1001. The table update processing unit 10001 is a block for updating the plane management table 1001 by responding to the fault detection information and plane switchover completion from the transmission device 110 and receiving the plane setting addition/change instructions from the maintenance IF 1003.

The fault influence degree calculation processing unit 10002 is a block for calculating fault influence degrees plane by plane on the basis of pieces of fault detection information of paths belonging to the individual planes in plane management table 1001, that is, information as to whether the path becomes incapable of transmitting data owing to the fault, and information indicative of a preferential degree of the path. The network status judgment processing unit 10003 is a block for determining an optimal plane by consulting the fault influence degrees of the individual planes in plane management table. When the optimal plane is caused to change by the fault, the processing unit 10003 instructs the network configuration setting controlling unit 10004 to switch over the plane. The network configuration setting controlling unit 10004 is a block for reporting to the communication processor 1002 the plane switchover instructions from the network status judgment processing unit 10003 and the plane setting addition/change instructions from the maintenance IF 1003.

The maintenance IF 1003 is an interface for informing a maintainer of the network management information and reflecting the plane setting addition/change instructions from the maintainer upon the network management information and is constituted by a display, a keyboard and the like. Alternatively, the maintenance IF may be a communication IF which is coupled to a more upper management network so as to be controlled remotely. In the present embodiment, the plane setting and addition is conducted via the maintenance IF 1003 but by storing, in the network management system 100, a processor adapted to execute calculation of a suitable plane, the plane setting and addition may be executed on the basis of information from that processor.

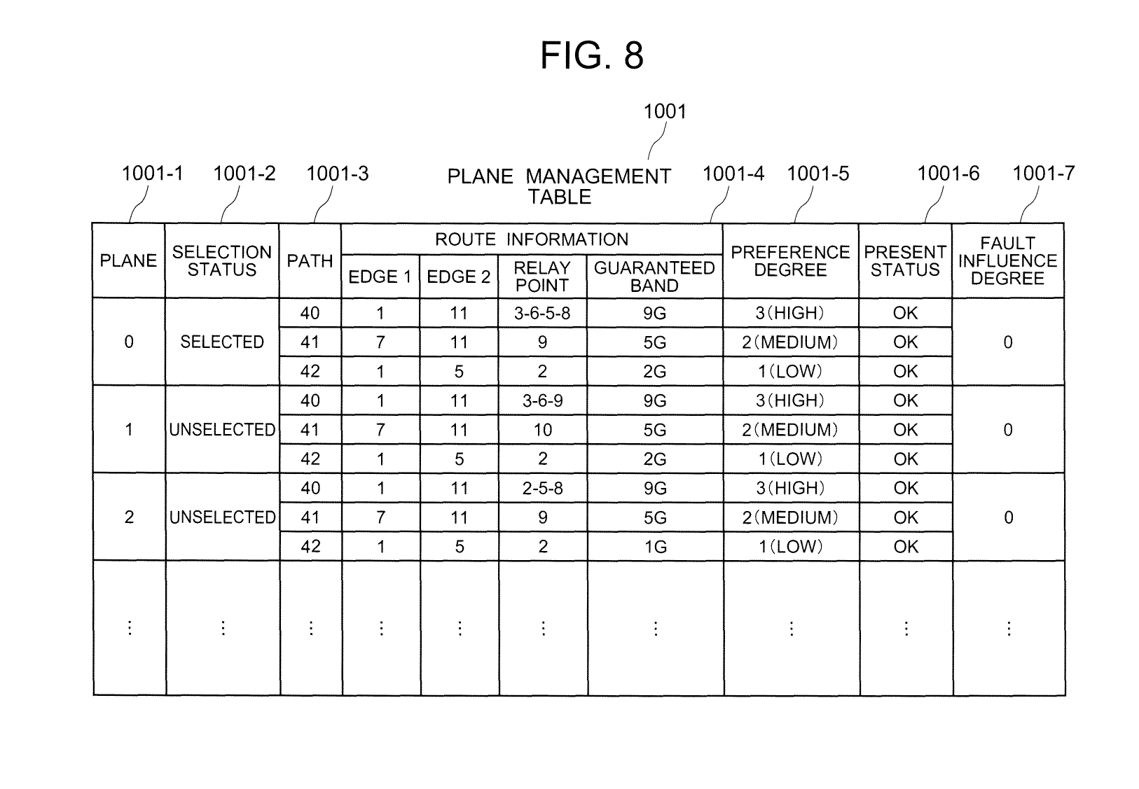

Referring now to FIGS. 8 to 11, the contents of plane management table 1001 and processing by the network information management controller 1000 will be described in greater detail.

An example of structure of plane management table 1001 of network management system 100 is shown in FIG. 8. In an item of plane 1001-1, pieces of information for identifying a working plane and a plurality of protection planes are indicated and in the present embodiment, the working plane, a first protection plane and a second protection plane are designated by plane 0, plane 1 and plane 2, respectively. In an item of selection status 1001-2, it is indicated which plane path configuration is selected at present by the transmission network 10. In an item of path 1001-3, a set of paths included in each of the planes is indicated, showing pieces of information for identifying paths included in the individual planes. In an item of route information 1001-4, details of the individual paths are indicated in order that a transmission route is expressed by identification information of a transmission device representing an edge of a path and identification information of a transmission device representing a relay point, and a guaranteed band which is a transmission band the path must guarantee is included. In an item of preference degree 1001-5, preference degrees of the aforementioned individual paths are indicated by numerical values and in the present embodiment, high preference, medium preference and low preference are designated by 3, 2 and 1, respectively. In an item of present status 1001-6, OK (devoid of fault) or NG (fault involved) is set on the basis of the presence or absence of a fault on each of the paths. In an item of fault influence degree 1001-7, the degrees of faults on the individual planes are indicated quantitatively and the number of paths subject to fault occurrence included on a plane is calculated by weighting it with degrees of preference of the paths. In a method of calculating a fault influence degree exemplified in the present embodiment, the sum of preference degrees of paths undergoing NG is defined as the fault influence degree. When no fault is generated on the transmission network 10, the present statuses of paths on the planes 0 to 2 are all OK as shown at 1001-6 in FIG. 8 and the fault influence degrees of the planes 0 to 2 are all 0 as shown at 1001-7 in FIG. 8.

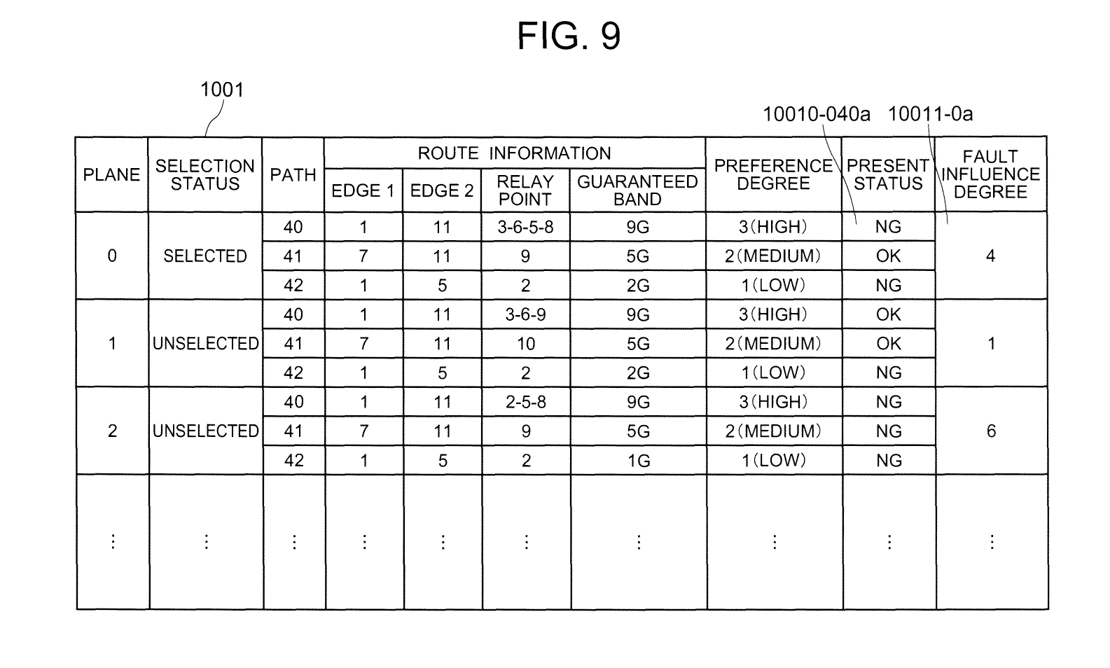

Shown in FIG. 9 is the status of plane management table 1001 after a fault has occurred in the neighborhood zone 30-1 illustrated in FIG. 5. After the occurrence of the fault in the neighborhood zone 30-1, the present status 10010-040a indicates that the paths 40 and 42 are NG. Then, the fault influence degree 10011-0a indicates 4 equaling the sum of 3 of preference degree of path 40 and 1 of preference degree of path 42. The plane 1 on which the path 42 undergoes NG takes a fault influence degree of 1 pursuant to the preference degree 1 of path 42. The plane 2 on which the paths 40, 41 and 42 undergo NG takes a fault influence degree of 6 pursuant to the sum of the preference degrees 3, 2 and 1 the paths 40, 41 and 42 have, respectively. Consequently, the plane 1 undergoing the minimal fault influence degree is determined as the optimal plane and the plane switchover is instructed.

The aforementioned calculation method of fault influence degree 10011-0a is a mere example and a different judgment criterion for optimal plane can be conceivable. For example, when it is thought much of the fact that a larger number of high preference paths can be made passable in selecting the plane, extreme weighting may be conducted by making, for example, 10000 the preference degree of a high preference path, 100 the preference degree of a medium preference path and 1 the preference degree of a low preference path. In contrast, when it is thought much of the fact that a larger number of paths can be made passable irrespective of the preference degrees in selecting the plane, the preference degrees may be equalized by making, for example, 1 the preference degree of a high preference path, 1 the preference degree of a medium preference path and 1 the preference degree of a low preference path.

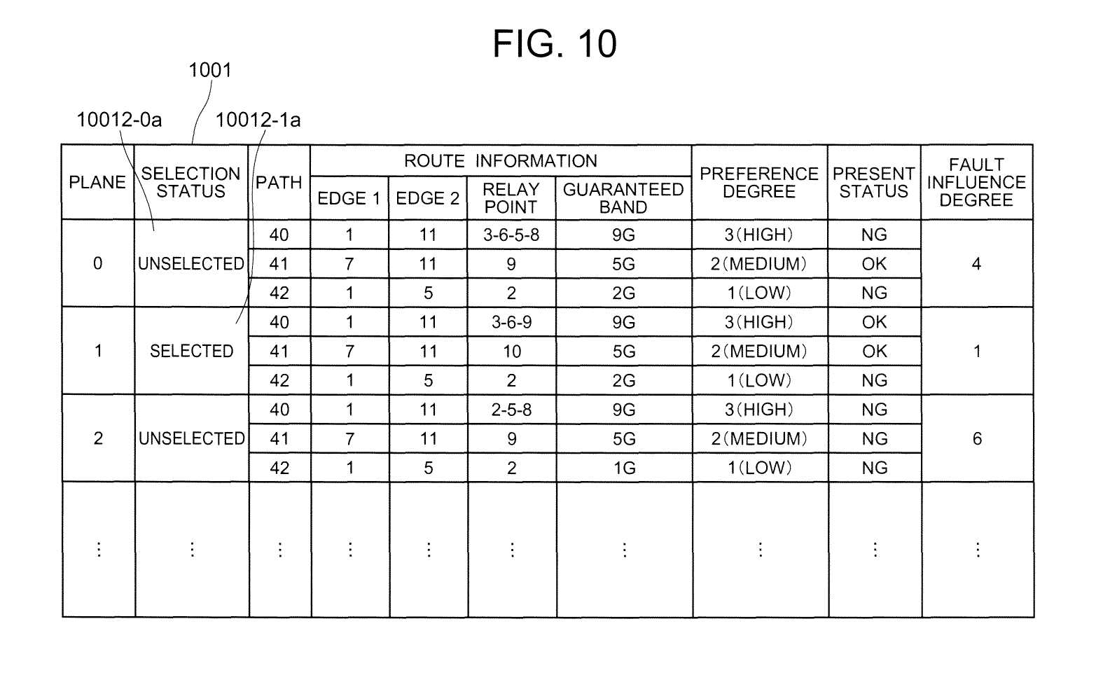

The network status judgment processing unit 10003 of network management system 100 determines the plane 1 as being the optimal plane and instructs the plane switchover. Subsequently, when finishing the plane switchover (changing a transfer table to be selected), each of the transmission devices 110 informs the network management system 100 of the completion, so that the selection status of the plane 0 can become unselected as shown at selection status 10012-0a and the plane 1 is conditioned for selection as shown at 10012-1a in FIG. 10.

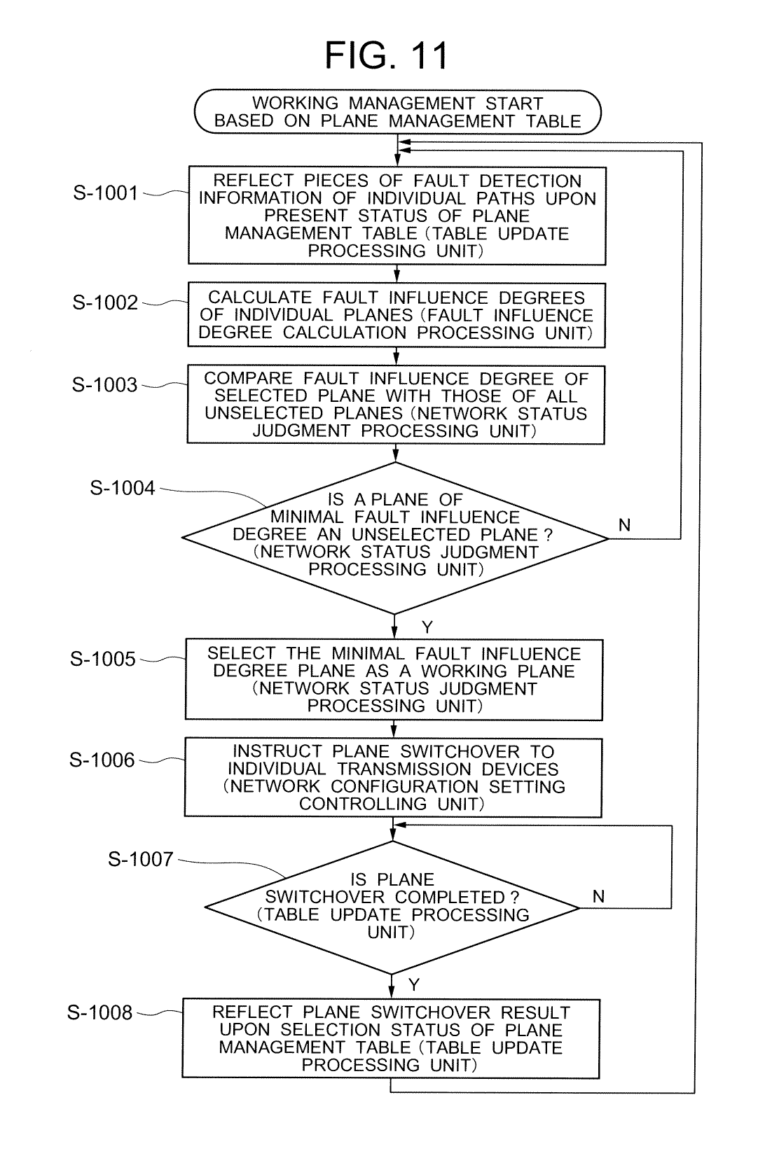

FIG. 11 shows a flowchart of processing by the network management controller 1000 of network management system 100. When the work management of transmission network 10 based on the plane management table 1001 is started, the network information management controller 1000 constantly reflects fault information of network upon the plane management table 1001, executes calculation/comparison of fault influence degrees plane by plane and carries out switchover of plane as necessary.

More specifically, the table update processing unit 10001 first reflects pieces of fault detection information of the individual paths upon the present status of plane management table 1001 in step (S-) 1001. Since the presence or absence of faults on the individual paths can be judged through the existing OAM technique, the present status 1001-6 of plane management table 1001 is updated in respect of each of the selected planes and each of the unselected planes on the basis of pieces of information reported from the individual transmission devices 110.

Next, on the basis of the present status 1001-6 of plane management table 1001, the fault influence degree calculation processing unit 10002 calculates fault influence degrees of the individual planes in step 1002. Thereafter, the network status judgment processing unit 10003 compares fault influence degrees of the selected planes and all of the unselected planes with one another in step 1003 and decides, in step 1004, a plane of the minimal fault influence degree as to whether to be an unselected plane.

If the plane of the minimal fault influence degree is determined as a selected plane, the plane selected at present is determined as optimal and the plane switchover is not executed, followed by again executing update of plane management table 1001 in the step 1001. With the plane of the minimal fault influence degree determined as an unselected plane, the unselected plane is determined as the optional plane in the present condition of the network and this plane is selected in step 1005. In order to reflect the selected plane upon the transmission network, the network configuration setting controlling unit 10004 instructs, in step 1006, the individual transmission devices 110 to switchover the plane.

A specified example of the plane switchover process in the respective transmission devices 110 will now be described.

Assumptively, an ID of a VLAN assigned to an Ether frame of access network 20-1 the transmission device 110-1 stores as path 40 is 40 and a MPLS label the path 40 has in the transmission network 10 is 400. When the plane 0 in FIG. 8 acts as a working plane, the table selector 11301 of transmission device 110-1 selects a transfer table 11302 corresponding to the plane 0 and when receiving a frame having the VLAN ID of 40 from the access network 20-1, the transmission device 110-1 allots the MPLS level 400 to the received frame to transmit it to the transmission device 111-3.

Subsequently, when receiving instructions to execute switchover of the plane 0 to the plane 2 in FIG. 8, for example, from the network management system 100, the transfer table manager 11303 of transmission device 110-1 informs the table selector 11301 of the fact that the plane is changed from plane 0 to plane 2. Then, the table selector 11301 selects a transfer table 11302 corresponding to the plane 2. When finishing the plane switchover, the transmission device 110-1 transmits to the network management system 100 a notice of completion. Subsequently, when receiving the frame having the VLAN ID of 40 from the access network 20-1, the transmission device 110-1 allots the MPLS label 400 to the received frame to transfer it to the transmission device 111-2 in turn.

Reverting to FIG. 11, a description will be given. Subsequently, in step 1007, completion of the plane switchover is judged depending on the fact that the table update processing unit 10001 has received notices of plane switchover completion from all of the instructed transmission devices 110. But, in case an objective transmission device per se instructed to switch over the plane becomes faulty and operates for fault detection or fails to respond, the presence or absence of the notice of plane switchover completion from that transmission device is excluded from the condition for making a decision, in the step 1007 of judging the plane switchover completion. When the completion of plane switchover is determined in the step 1007, the table update processing unit 10001 reflects a selected status of the plane after the switchover upon the selected condition 1001-2 of plane management table 1001 and returns, in step 1008, to the process in the step 1001.

### 2. Embodiment 2

In the present embodiment, an example of the transmission network will be described in which when, after the operation of plane switchover described in embodiment 1 has been executed, a bypass having no influence upon transmission through other normal paths exists in association with the interrupted path, the path is so changed as to be passable by using the bypass. In the embodiment 1, a path configuration status will sometimes be selected in which even when a bypass exists in association with the path becoming interrupted after the plane switchover, the bypass is not used. This inconvenience may take place when a range in which a fault occurs actually is smaller than a predetermined fault assumptive range. But, by applying the present embodiment, a bypass can be assured as far as possible in association with a low preferential path which is interrupted after a route of a high preferential path has been assured swiftly through a plane switchover and, consequently, a more suitable plane can be set.

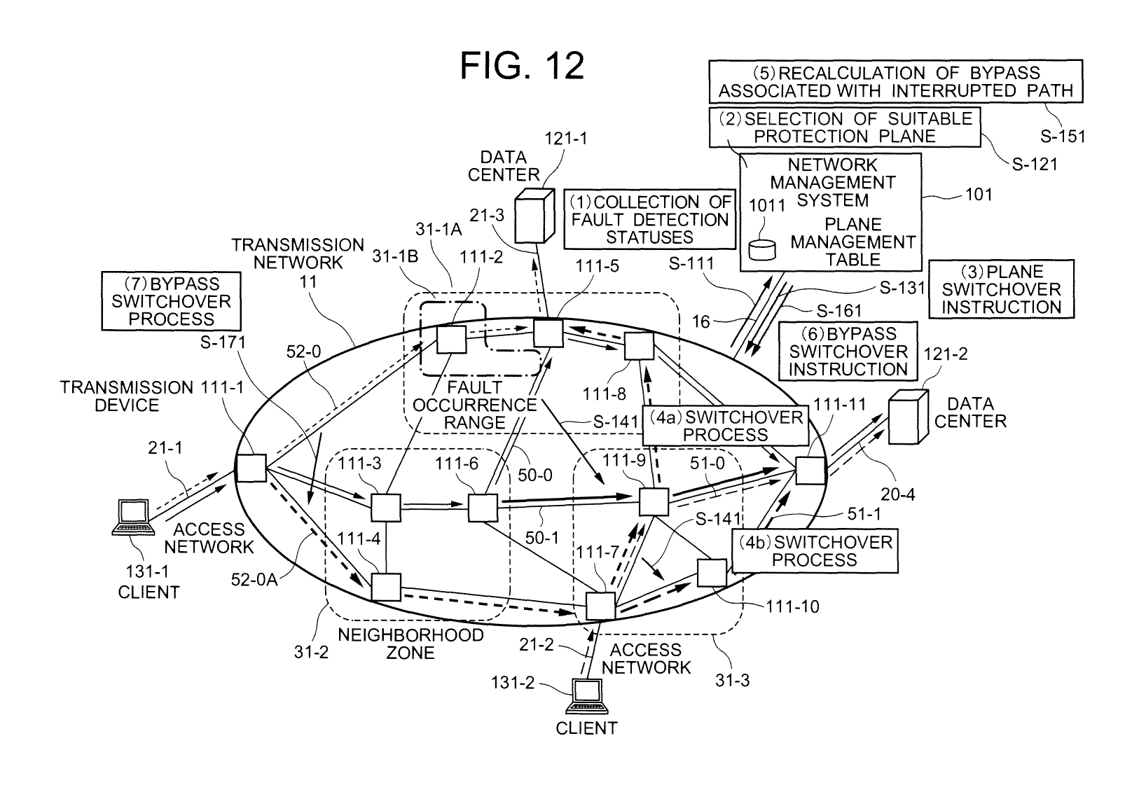

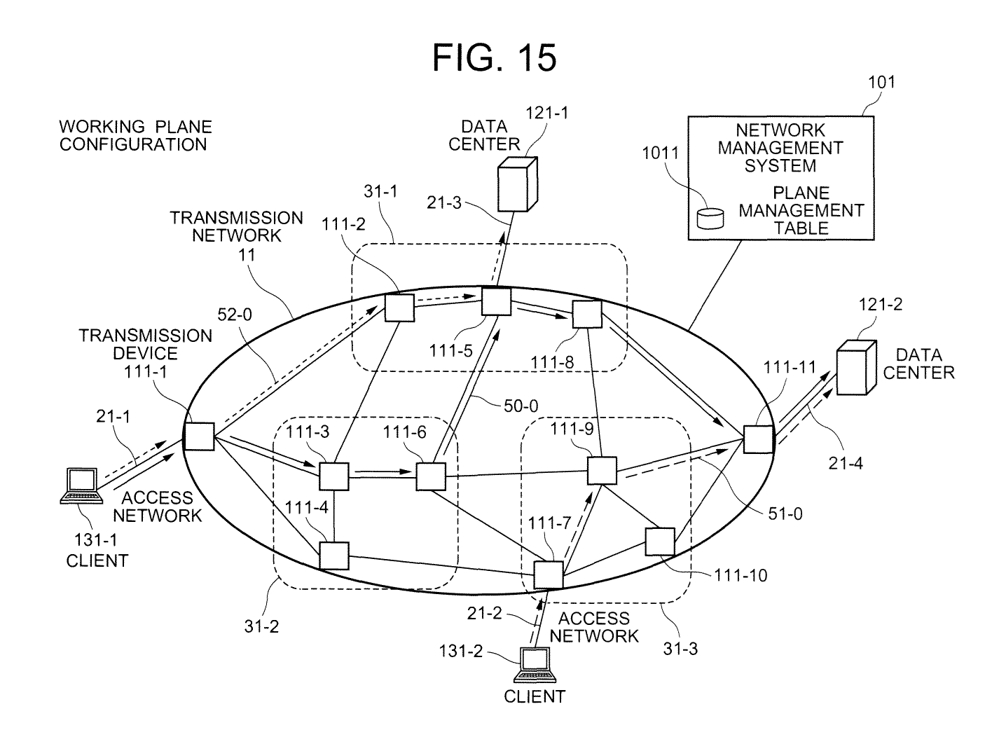

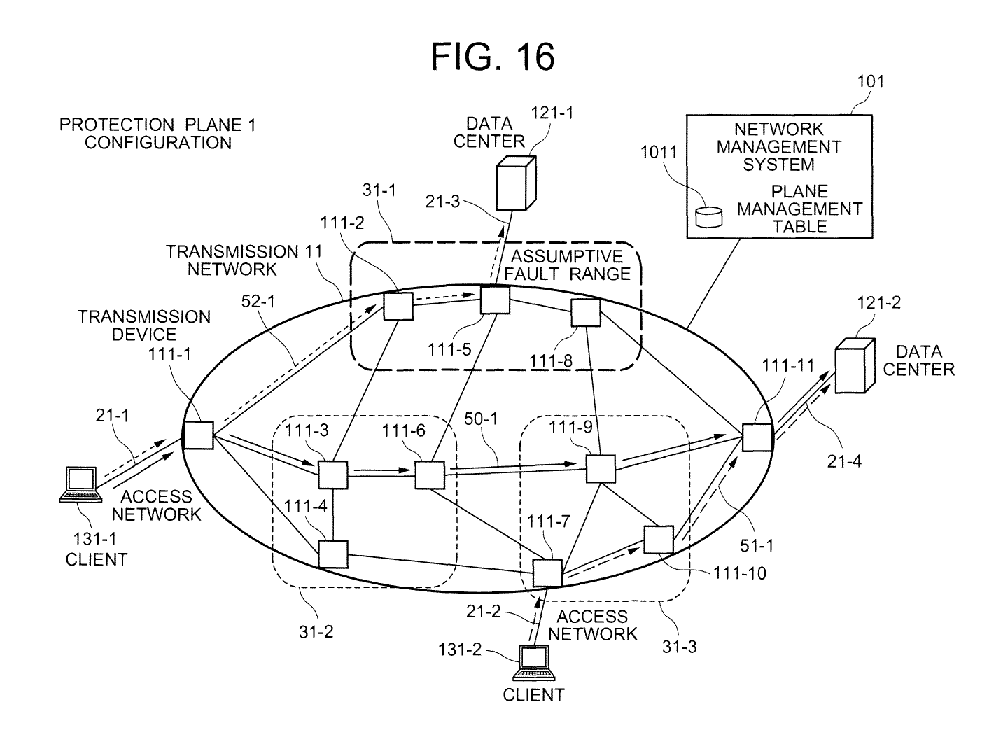

Turning to FIG. 12, an example of switchover operation at the time of fault occurrence on the transmission network 11 according to the present embodiment will be described. In this example, a fault occurs in a region 31-1B surrounded by dotted chained line and communication is interrupted. However, the fault occurrence range assumed in preparing the protection plane corresponds to the zone 31-1A and is wider than the actual fault occurrence range 31-1B. Therefore, according to the operation of embodiment 1, the network management system 101 changes a selection plane from the working plane illustrated in FIG. 15 to the first protection plane illustrated in FIG. 16. As a result, in spite of the fact that the transmission devices 111-5 and 111-8 included in the assumptive fault range 31-1A can function, a path routing these devices will not sometimes be used. In this manner, the low preferential path 52-0 indicated at thinner dotted line is interrupted in FIG. 16.

In the embodiment 2 shown in FIG. 12, the interrupted path 52-0 is switched over to a bypass 52-0A. This operation will be described hereunder.

When a fault occurs in the neighborhood zone 31-1A, the path 50-0 indicated at thin solid line and a path 52-0 indicated at thin dotted line on the working plane are interrupted, the transmission devices 111 for routing these paths detect the fault and inform the network management system 101 of the fault in step 111. The network management system 101 reflects the fault information upon the plane management table 1011 and on the basis of results of calculation and comparison of fault influence degrees of the individual planes, selects a suitable plane (first protection plane) in step 121. On the basis of the result of plane selection, the network management system 101 instructs, in step 131, the individual transmission devices 111 to change the plane. In the case of this example, switchover from the working plane to the first protection plane is instructed. In this instance, another path for relieving the path 52-0 is not set on the selected protection plane.

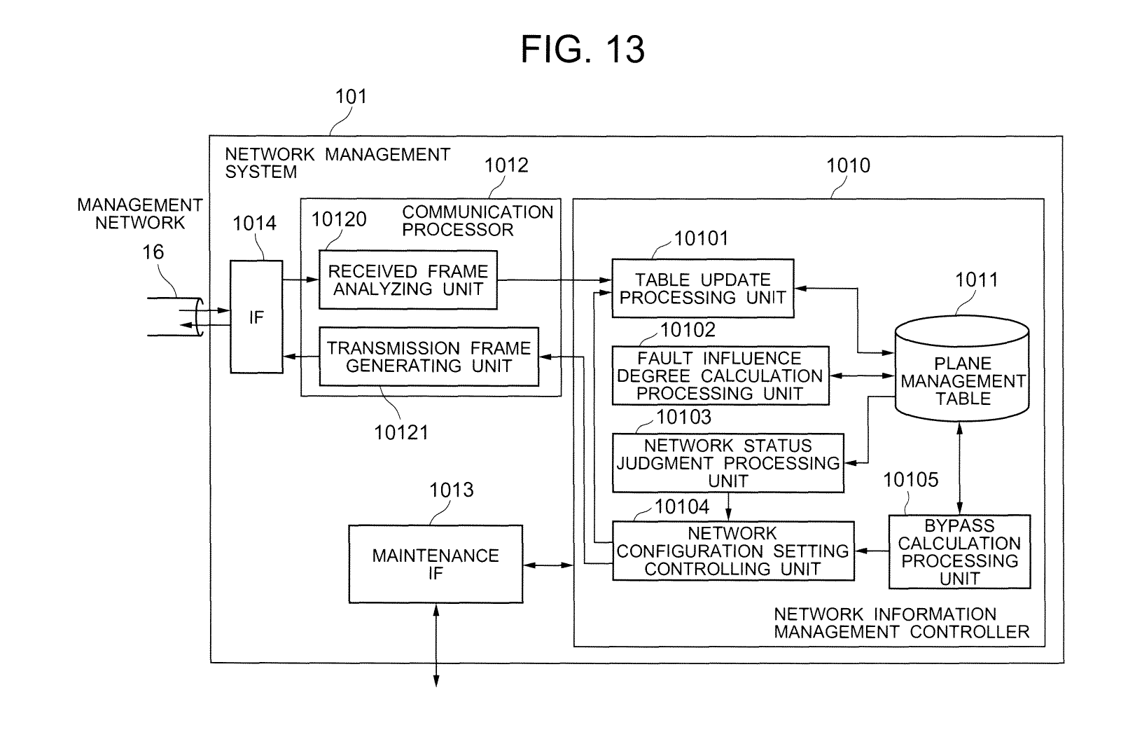

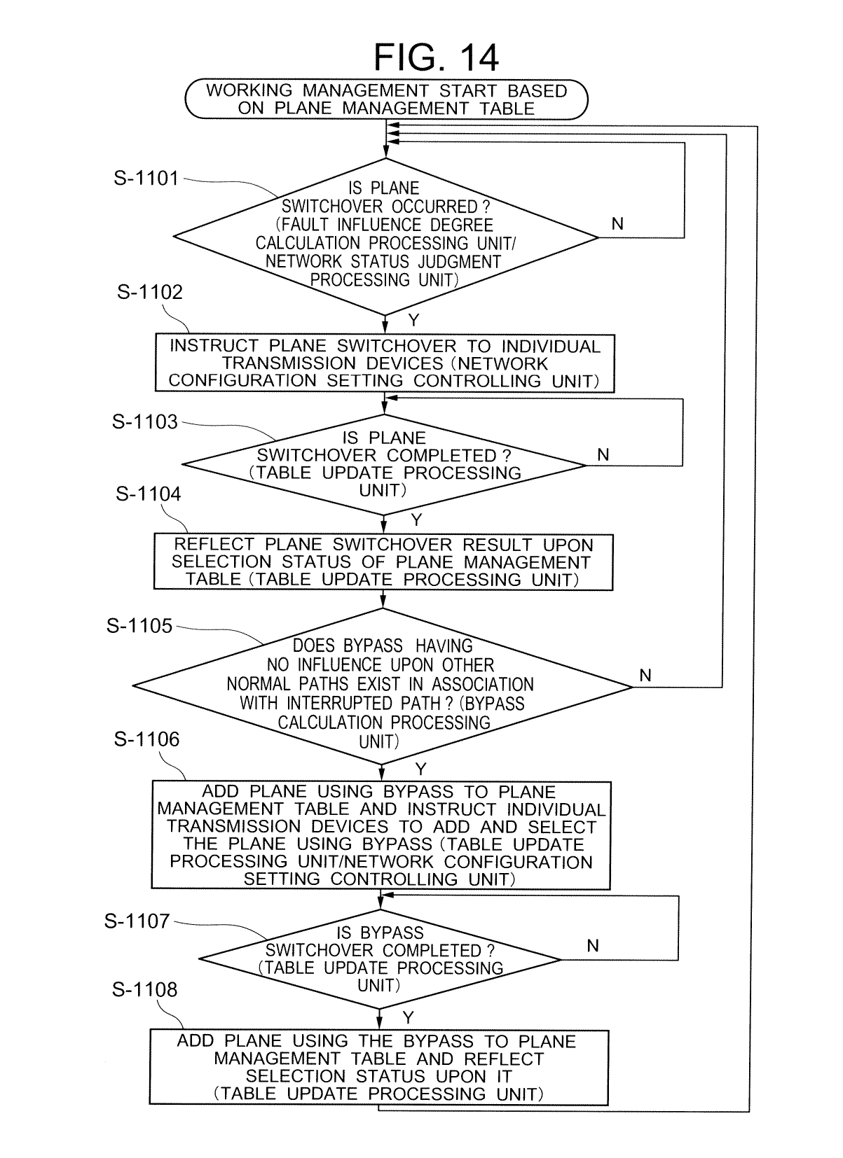

When receiving the plane switchover instruction, each of the transmission devices 110 carries out selection plane change on the basis of the instruction in step 141. Thereafter, the network management system 101 searches, in step 151, a bypass for the interrupted path 52-0 to capture a path 52-0A indicated at thick dotted line which relays the transmission devices 111-4, 111-7, 111-9 and 111-8 sequentially. The network management system 101 distributes to the individual transmission devices 111 information of a new plane including the newly obtained bypass. Then, the network management system 101 instructs, in step 161, switchover to a plane on which the path 52-0 is changed to the path 52-0A and the transmission device 111 in receipt of the instruction conducts the switchover process in step 171. A functional block and processing of network management system 101 for materializing the present operation will be detailed with reference to FIGS. 13 and 14. To add, the present embodiment can be realized by structuring the transmission device 111 and the network management table 1011 similarly to the transmission device 110 and network management table 1001 shown in FIGS. 6 and 8, respectively.

Illustrated in FIG. 13 is a functional block diagram of the network management system 101. The network management system 101 includes a network information management controller 1010, a communication processor 1012, a maintenance IF 1013 and an IF 1014 coupled to the management network 16. The communication processor 1012, the maintenance IF 1013 and the IF 1014 coupled to the management network 16 are functional blocks which conduct similar processes to those by the communication processor 1002 and maintenance IF 1003 the network management system 100 includes and the IF 1004 coupled to the management network 15, respectively. Further, the plane management table 1011, fault influence degree calculation processing unit 10102 and network status judgment processing unit 10103 the network status management controller 1010 includes are functional blocks which conduct similar processes to those by the plane management table 1001, fault influence degree calculation processing unit 10002 and network status judgment processing unit 10003, respectively, the network management system 100 as shown in FIG. 7 includes.

A bypass calculation processing unit 10105 of network information management controller 1010 is a processing unit for searching a bypass for a path becoming NG status at present by consulting the plane management table 1011. In respect of the individual transmission routes, a numerical value obtained by subtracting the sum of guaranteed bands of paths using the transmission route from the transmission band 10 Gbps is managed as a residual band and, out of routes existing as transmission paths between edge transmission devices on the NG path, a route having the biggest residual band is selected as a bypass. Extraction of the routes existing as the transmission paths between the edge transmission devices on the NG path is executed by determining, out of all transmission routes in the transmission network, transmission routes used by the NG path but unused by the OK path as abnormal transmission routes and by calculating transmission routes between edge transmission devices between on the NG path from a set of normal transmission routes excluding the abnormal transmission routes.

Even when, as compared to the essentially guaranteed band of the path, the residual band of the bypass is insufficient, the residual band of bypass is set as the guaranteed band of the path. This setting is done for the sake of having no influence upon the transmission bands of the existing paths. Since the path to be set with a bypass can be set at the cost of degenerating its transmission band to the residual band of the bypass, the total interruption can be avoided at the cost of failing to assure the guaranteed band.

In the event that a plurality of paths undergo NG, bypasses can be assured starting from a bypass for a high preference path by first searching the bypass associated with the high preference path and subsequently, searching bypasses associated with residual paths. The bypass calculation processing unit 10105 uses for a new plane a network configuration in which bypasses associated with NG paths are assured as many as possible and instructs the network configuration setting controlling unit 10104 to add and select the plane.

The network configuration setting controlling unit 10104 conducts the process by network configuration setting controlling unit 10004 of network management system 100 illustrated in FIG. 7 and in addition, when receiving instructions for addition and selection of a new plane from the bypass calculation processing unit 10105, instructs the table update processing unit 10101 to add the plane to the plane management table 1011 and also, instructs each of the transmission devices 111 to add and select the new plane.

The table update processing unit 10101 conducts the process by table update processing unit 10001 of network management system 100 illustrated in FIG. 7 and in addition, when receiving instructions to add the new plane from the network configuration setting controlling unit 10104, adds the new plane to the plane management table.

A flowchart showing the process by network information management controller 1010 of network management system 101 is shown in FIG. 14. When working management of transmission network 11 based on the plane management table 1011 is started, the network information management controller 1010 constantly reflects network fault information upon the plane management table 1011, conducts calculation and comparison of fault influence degrees of the individual planes and as necessary, carries out switchover of plane in steps 1101 to 1104. Details of these processes are similar to the processes in steps 1001 to 1008 in the network information management controller 1000 according to embodiment 1 shown in FIG. 11.

Subsequently, by consulting the plane management table 1011, the bypass calculation processing unit 10105 confirms, in step 1105, whether an interrupted path exists on a plane presently selected and searches whether a bypass associated with the interrupted path and having no influence upon other normal paths is exists. In the absence of the bypass, the plane after the plane switchover execution is determined as an optimal plane and the program returns to the step 1101. In the presence of the bypass, instructions to newly add and select the plane configuration using the bypass are reported, in step 1106, to the network configuration setting controlling unit 10104, which in turn instructs the table update processing unit 10101 to newly add the plane so that the plane may be added to the plane management table 1011 and also, instructs the individual transmission devices 111 to newly add and select the plane.

The transfer table manager 11303 of the transmission device 111 instructed by the network management system 101 to add and select the new plane adds a transfer table 11302 corresponding to the new plane and instructs the table selector 11301 to select the new transfer table 11302. After finishing selection of the new plane, the transfer table manager 11303 reports a notice of completion to the network management system 101.

Thereafter, the table update processing unit 10101 makes a decision, in step 1107, as to whether the bypass switchover is completed by depending on whether the unit 10101 has received notices of plane addition/selection completion from all of the transmission devices the unit 1010 has instructed. If determining that the bypass switchover has been completed in the step 1107, the table update processing unit 10101 selects, in step 1108, the status of selection of the plane on which the bypass switchover is added in the plane management table 1101.

In this manner, when after execution of plane switchover, a bypass having no influence upon the passage and guaranteed band of other normal paths exists in association with the interrupted path, switchover to a plane using the bypass is newly carried out, thus making it possible to conduct a change to a more proper network configuration.

### 3. Embodiment 3

In the present embodiment, an example of transmission network will be described in which when a fault occurs in the transmission network, a path switchover based on the conventional fast path protection switchover function is carried out immediately and as a result, if the whole network configuration is determined unsuitable, the plane switchover described in embodiment 1 is carried out to optimize the network configuration.

In the conventional path protection switchover function in the static path control, a path configuration is general in which when a fault occurs at a single spot, a path causing any of a working path and a protection path to be interrupted will not be generated and besides, a design can be made relatively easily in which the congestion and the localization of path can be minimized even after path switchover concomitant with the fault. On the other hand, the switchover described in connection with embodiment 1 or 2 is a scheme in which the network management system first collects the pieces of fault information and subsequently, an optimal one is selected from predetermined planes to conduct switchover and this scheme is more suitable for an instance where, for example, so large a fault as to require simultaneous switchover of a plurality of paths takes place. As will be seen from the above, the present embodiment presumes the path switchover of a relatively large scale led by the network management system having collected the pieces of fault information and is, therefore, disadvantageous in that the time to switchover is prolonged as compared to the path protection switchover function in which the transmission device conducts path switchover by itself or under self-control.

In the light of the above two points, it can be concluded that in the case of a fault occurring at a single spot, execution of the fast switchover based on the conventional path protection switchover function prefers to the execution of plane switchover. By applying the third embodiment, the path switchover based on the path protection switchover function is executed immediately at the time a fault occurs in the transmission network and if the result is improper for the overall network configuration, a change to a proper network configuration can be executed through the plane switchover.

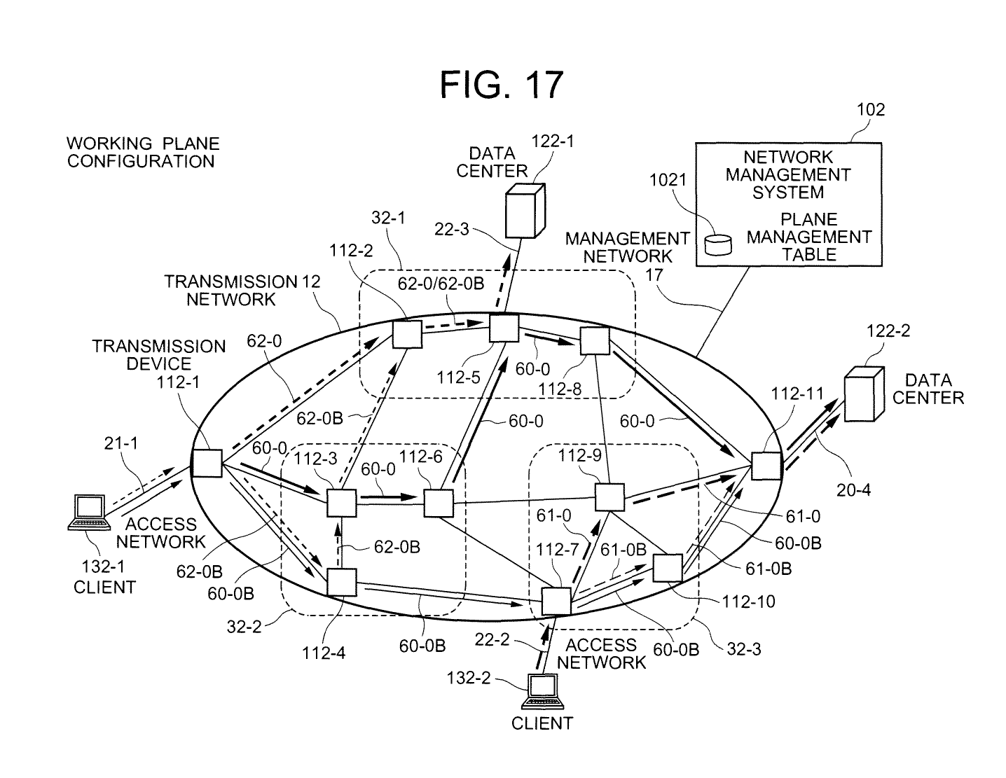

An example of a path configuration on the working plane of transmission network according to the present embodiment is illustrated in FIG. 17. The present embodiment differs from embodiment 1 in that protection paths are set in advance in association with respective working paths on a working plane. The protection path is for use in the path protection switchover function in the conventional static path control and a protection path system is switched over by the transmission device 112 by itself. In FIG. 17, a protection path 60-0B indicated at thin solid line is in association with a path 60-0 indicated at thick solid line, a protection path 61-0B indicated at thin dashed line is in association with a path 61-0 indicated at thick dashed line, and a protection path 62-0B indicated at thin dotted line is in association with a path 62-0 indicated at thick dotted line.

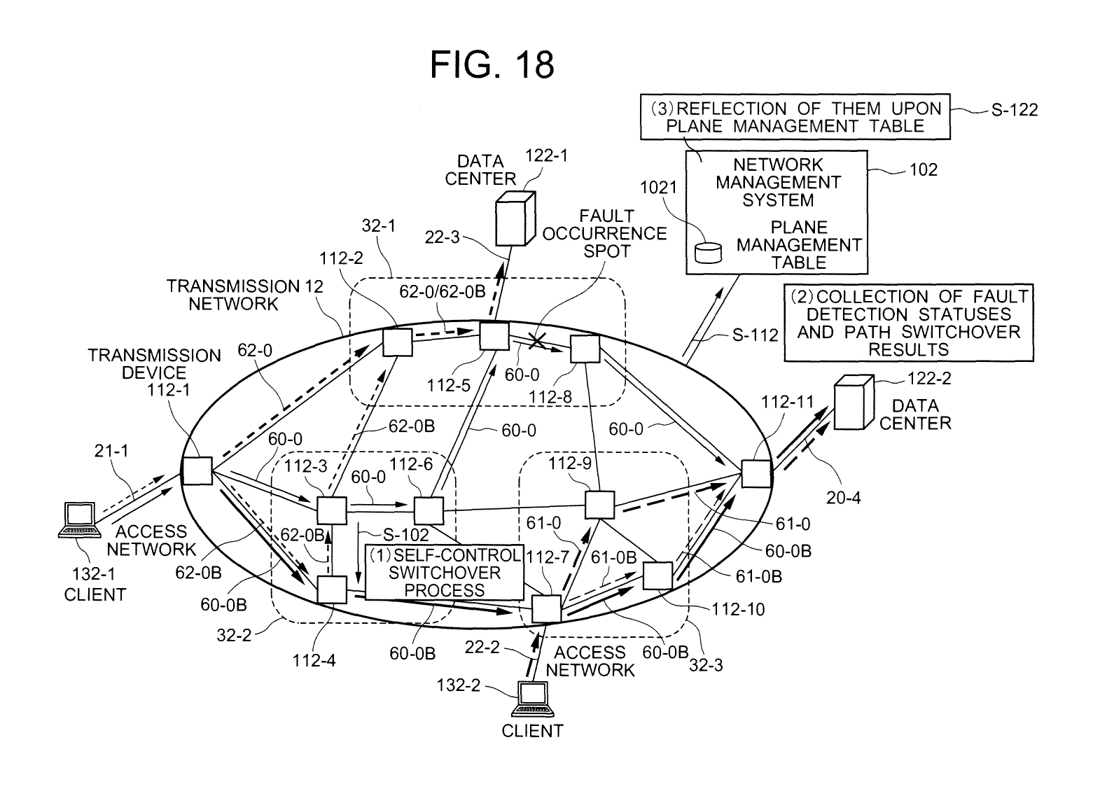

An example of switchover operation at the time of occurrence of a fault in the transmission network 12 according to the present embodiment is illustrated in FIG. 18. In this example, operation will be described in which when a fault occurs on a transmission route between transmission devices 112-5 and 112-8 in transmission network 12, the path 60-0 at thin solid line is switched over to the protection path 60-0B at thick solid line. This switchover operation is achieved by the path protection switchover function representing the conventional technique.

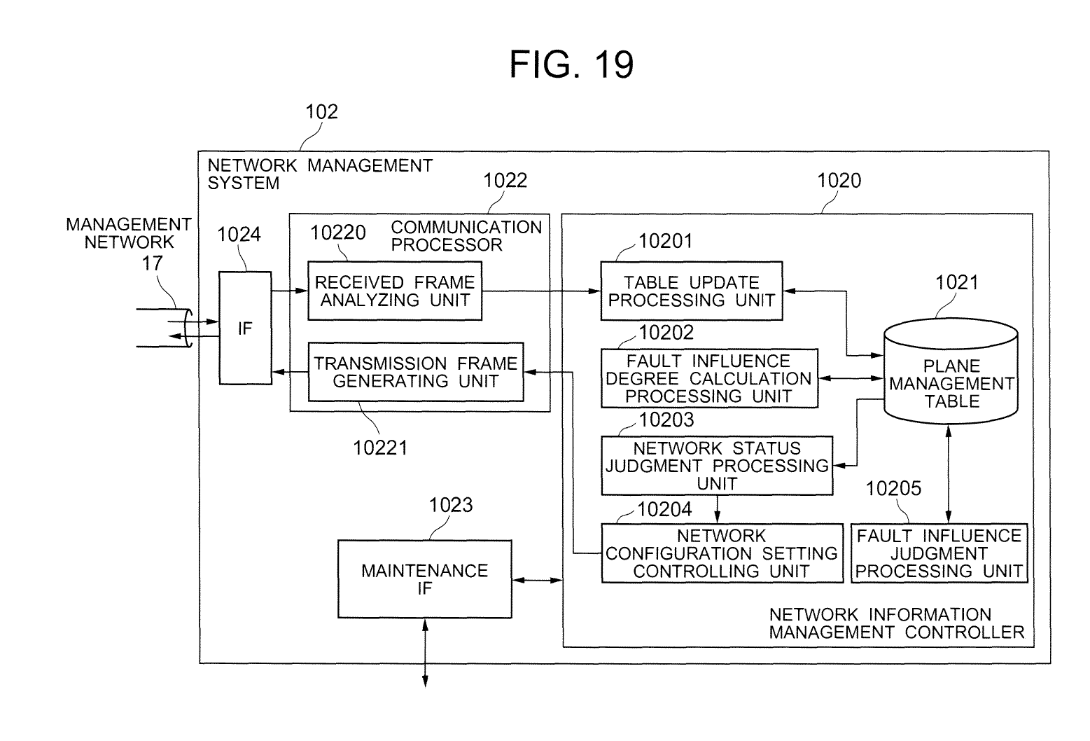

Edge transmission devices 112-1 and 112-11 detecting the fault on the path 60-0 through the OAM function execute fast path switchover to the path 60-0B under self-control as indicated at in S-102. The fault detection status and path switchover result are collected by the network management system 102 as indicated at S-112 and are reflected upon the plane management table 1021 as indicated at S-122. In this manner, relief of the network is tried in the transmission network 12 according to the present embodiment pursuant to the fast path transfer in the event of occurrence of the fault. But, in case both of the working path and protection path of any path are interrupted owing to a fault of large scale or congestion occurs in any transmission route owing to generation of a plurality of path switchovers, thus failing to take a suitable network configuration through only the path transfer, changing the network configuration based on the plane switchover as described in connection with the embodiments 1 and 2 is carried out. The contents of the plane management table 1201 and the functional block of network management system 102 for materializing the present operation will be described in greater detail with reference to FIGS. 19 to 21. To add, with the transmission device 112 constructed similarly to the transmission device 110 shown in FIG. 6, the present embodiment can be materialized.

Illustrated in FIG. 19 is a functional block diagram of the network management system 102. The network management system 102 includes a network information management controller 1020, a communication processor 1022, a maintenance IF (interface) 1023 and an IF 1024 coupled to the management network 17. The communication processor 1022 and maintenance IF 1023 and the IF 1024 coupled to the management network 17 are functional blocks which conduct processes similar to those by the communication processor 1002 and maintenance IF 1003 and the IF 1004 coupled to the management network 15, respectively, the network management system 100 as shown in FIG. 7 includes. Further, the table update processing unit 10201, fault influence degree calculation processing unit 10202, network status judgment processing unit 10203 and network configuration setting control unit 10204 included in the network information management controller 1020 are functional blocks which conduct processes similar to those by the table update processing unit 10001, fault influence degree calculation processing unit 10002, network status judgment processing unit 10003 and network configuration setting control unit 10004, respectively, the network management system 100 as shown in FIG. 7 includes.

The fault influence judgment processing unit 10205 in network information management controller 1020 is a block for deciding the plane switchover as to whether to be necessary or not and by consulting the plane management table 1021, decides the status as to whether to be expressed by “a path on which both a working path and a protection path are interrupted exists” or “a transmission path in which the sum of guaranteed bands of accommodated paths exceeds a transmission band of 10 Gbps”. When any of the condition is satisfied, a status is determined in which a large scale fault occurs in the transmission network 12 and consequently, a suitable network configuration cannot be taken through only the path switchover and so the plane switchover is necessary.

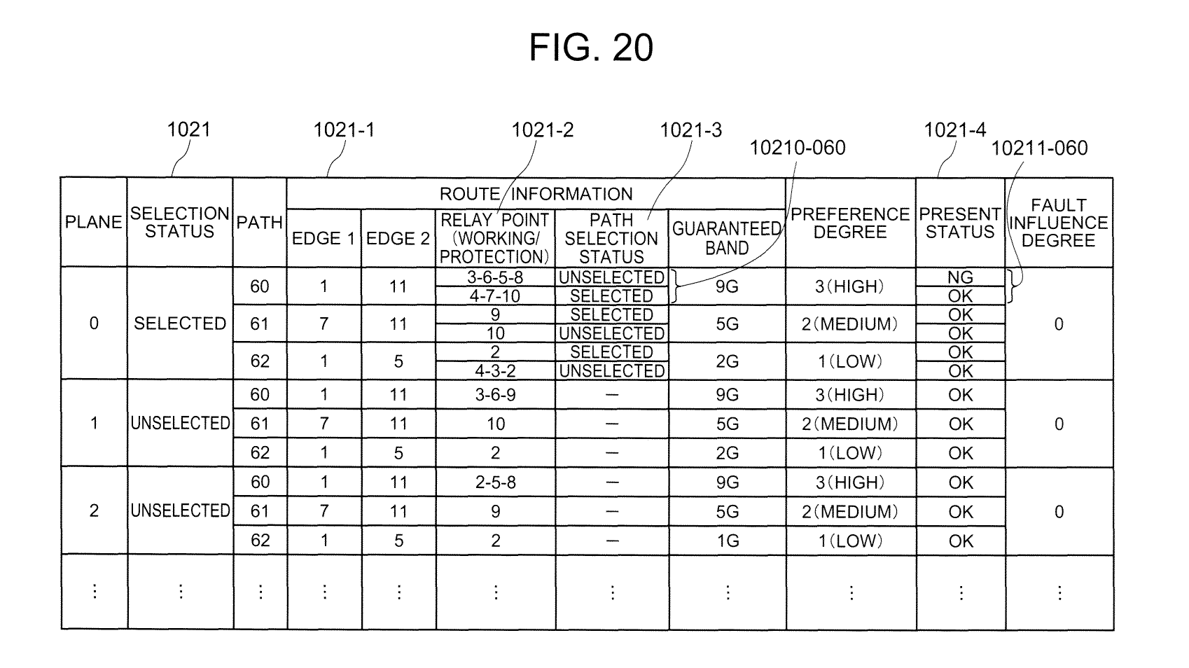

An example of the structure of plane management table 1021 of network management system 102 is shown in FIG. 20. The plane management table 1021 mainly differs from the plane management table 1001 shown in FIG. 8 in that in respect of an item of route information 1021-1 concerning a selected plane 0, sub-items of relay point 1021-2 and path selection status 1021-3 include each pieces of information of working path and protection path and an item of present status 1021-4 also includes pieces of information of working path and protection path.

In the figure, items of present status 1021-4 and path selection status 1021-3 indicate status which is generated after the path switchover in the event that the fault occurs as shown in FIG. 18. Reflected upon the plane management table 1021 in FIG. 20 is a status in which because of the fault, the present status 10211-060 of the working path 60-0 of path 60 on the 0 plane undergoes NG and after generation of a path switchover by the transmission device by itself, a path selection status 10210-060 of the path 60 occurs in which the protection path 60-0B is selected.

To add, in the present embodiment, the most essential configuration is described in which the protection path is set in advance in association with each path on only the plane 0 representing the working plane but in order to make possible the switchover based on the fast path protection switchover function even after the switchover to the protection plane, protection paths may also be set in advance in association with paths on the planes 1 and 2 representing protection planes or, upon switchover from the working plane to the protection plane, protection paths associated with the individual paths may be set additionally.

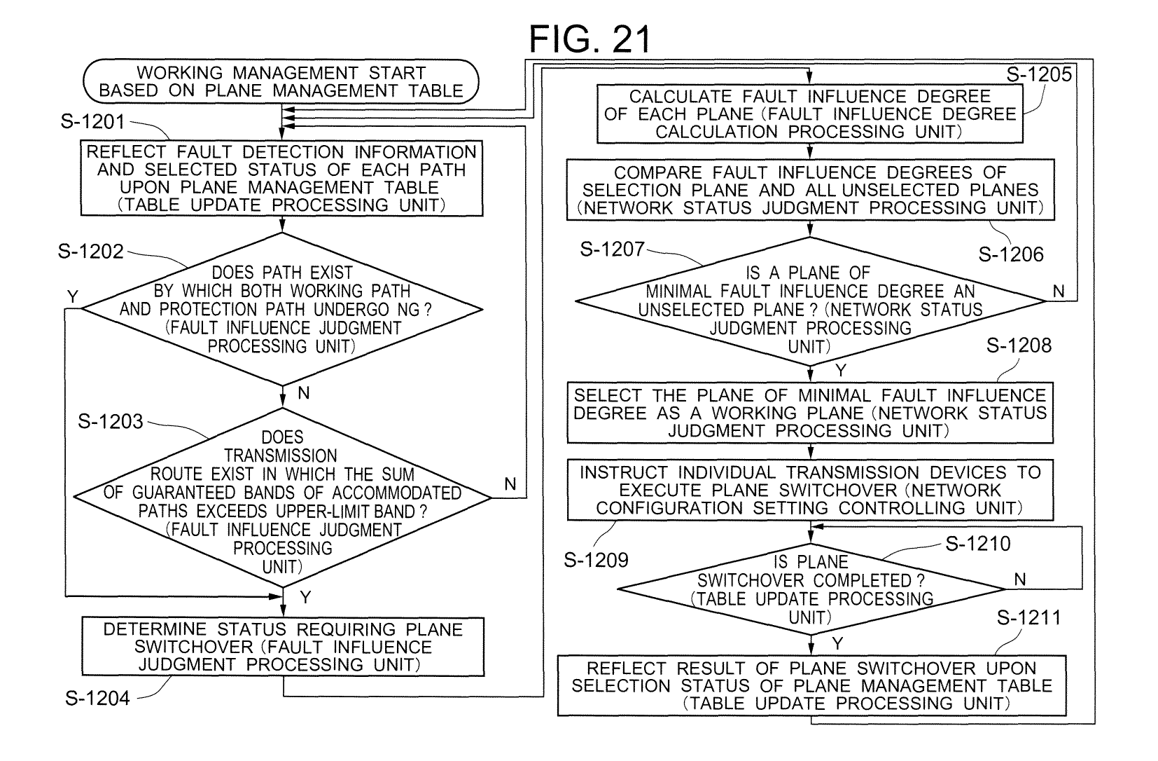

A flowchart showing processing by the network information management controller 1020 of network management system 102 is shown in FIG. 21. In the present embodiment, if a proper network configuration cannot be taken by conducting only the conventional path switchover, the plane switchover will be carried out on specified conditions for conducting the plane switchover that “a path exists for which the working path and the protection path are both interrupted” or “a transmission route exists for which the sum of guaranteed bands of accommodated paths exceed the upper-limit band.” The former condition indicates the presence of an interrupted path and the latter condition indicates possible congestion. The upper-limit band indicates the upper limit of transmissible band in a transmission route and in the present embodiment, 10 Gbps prevails. When working management of transmission network 12 based on the plane management table 1021 is started, the network information controller 1020 causes the table update processing unit 10201 to constantly reflect network fault information upon the plane management table 1021 in step 1201. By consulting the plane management table 1021, the fault influence judgment processing unit 10205 decides, in step 1202, whether a path exists for which the working path and the protection path are both interrupted. A decision is also made, in step 1203, as to whether the sum of guaranteed bands of accommodated paths exceeds the upper-limit band. If neither the decision in the step 1202 nor the decision in the step 1203 is satisfied, update of the plane management table is again carried out in the step 1201, so that if either one is satisfied, a status for which the plane switchover is necessary is determined in step 1204 and the plane switchover is tried through processing in the succeeding steps 1205 to 1211. These processes can be materialized through similar processes in the steps 1002 to 1008 shown in FIG. 11.

As described above, in the embodiment 3, the path switchover based on the path protection switchover function is carried out instantaneously at the time a fault occurs in the transmission network and when the result indicates an unsuitable status for the overall network configuration, changing to a suitable network configuration can be conducted through the plane switchover.

While, in the foregoing embodiments, the path is explained as being a transmission route between edge transmission devices, these embodiments can be practiced in a similar way even by considering a transmission route between arbitrary transmission devices in the transmission networks 10, 11 and 12 as a path.

According to the foregoing embodiments, in stretching paths between the transmission devices in the network, plural patterns of combinations of paths are prepared on the assumption of fault occurring spots in the network with a view to avoiding the fault occurring spots and when a fault occurs, one of the prepared plural path combination patterns is selected and paths are switched over at a time. For example, in the event that a large earthquake hits a particular area and a fault of large scale takes place therein, the conventional switchover in a unit of path will consume much time for restoration or will cause interruption of an important communication route (path). Contrarily, according to the present embodiment, the important path can be remedied in a short period of time.

It will be appreciated that as explained in connection with FIG. 10, a path of relatively low importance degree will not always be remedied depending on a selected plane. But an instance will occur in which even at the cost of interruption of the path of low importance and urgency, that is, of low preference, a path of high importance needs to be remedied in a short period of time. For example, in the event of the occurrence of a disaster of large scale, a communication route (path) for a system of instructions by the government should not be interrupted. In such an event, by applying the present embodiment, at least an important path can keep continuing communications.

To add, in applying the method according to the embodiment 2, a path of not so high importance can also be remedied later on.

It should be further understood by those skilled in the art that although the foregoing description has been made on embodiments of the invention, the invention is not limited thereto and various changes and modifications may be made without departing from the spirit of the invention and the scope of the appended claims.

1. A transmission network comprising:
a network management system for managing and controlling the transmission network constituted by a plurality of transmission devices coupled mutually through transmission routes,
wherein said network management system includes a plane management table adapted to manage transmission planes defined by a set of paths in said transmission network,
said plane management table having the function to set and manage a working plane applied during normal operation and besides, a single or a plurality of protection planes applicable in the event of occurrence of a fault in said transmission network so that when a fault occurs in said transmission network, the applied plane may be changed to a suitable transmission plane.

2. The transmission network according to claim 1, wherein a plane optimal for a case of simultaneous occurrence of faults in said transmission devices and said transmission routes belonging to a geographical zone in said transmission network is set as said protection plane in said plane management table.

3. The transmission network according to claim 1, wherein in addition to a path belonging to said working plane, a path belonging to said protection plane is also monitored for its status constantly so as to reflect the result of monitoring upon said plane management table.

4. The transmission network according to claim 1, wherein said plane management table memorizes, in mutually corresponding relationship, identification numbers of said working plane and said protection plane, pieces of information indicative of all paths belonging to the respective planes and fault influence degrees indicative of degrees of influences by faults of the respective planes.

5. The transmission network according to claim 4, wherein the number of paths which are interrupted is used for calculating said fault influence degree.

6. The transmission network according to claim 4, wherein the number of interrupted paths weighted according to their preference degrees is used for calculating said fault influence degree.

7. The transmission network according to claim 4, wherein said network management system constantly compares a fault influence degree of said working plane with that of said protection plane and when a plane having the minimal fault influence degree differs from a plane applied presently, the plane having the minimal fault influence degree is selected as the plane to be applied.

8. The transmission network according to claim 1, wherein in case after the applied plane is changed to a suitable plane in the event of occurrence of a fault in said transmission network, a bypass exists which is associated with an interrupted path and does not have an adverse influence upon paths normally passable, the interrupted path is relieved by using said bypass.

9. The transmission network according to claim 1, wherein in association with paths belonging to said working plane, a protection path to be used in the event of occurrence of a fault of a normally used working path is set in advance, switchover in a unit of path is carried out at the time of occurrence of a fault and, when the result of the switchover is in a status unsuitable for the overall network configuration, switchover in a unit of plane is carried out.

10. The transmission network according to claim 9, wherein when, in an applied plane, a path exists by which any of said working path and said protection path is interrupted, the overall network configuration is so judged as to be in improper status and switchover in a unit of plane is carried out.

11. The transmission network according to claim 9, wherein when, in an applied plane, a transmission route exists in which congestion occurs, the overall network configuration is so determined as to be in improper status and switchover in a unit of plane is carried out.

12. A transmission network management scheme for managing a transmission network comprised of a network management system adapted to collectively manage and control a plurality of transmission devices coupled mutually through transmission routes and the transmission network,
wherein said network management system includes a plane management table adapted to manage transmission planes defined by a set of paths in said transmission network,
said plane management table having the function to set and manage a working plane applied during normal operation and besides, a single or a plurality of protection planes applicable in the event of occurrence of a fault in said transmission network so that when a fault occurs in said transmission network, the applied plane may be changed to a suitable transmission plane.

13. The transmission network management scheme according to claim 12, wherein a plane optimal for a case of simultaneous occurrence of faults in said transmission devices and said transmission routes belonging to a geographical zone in said transmission network is set as said protection plane in said plane management table.

14. The transmission network management scheme according to claim 12, wherein said plane management table memorizes, in mutually corresponding relationship, identification numbers of said working plane and said protection plane, pieces of information indicative of all paths belonging to the respective planes and fault influence degrees indicative of degrees of influences by faults of the respective planes.

15. The transmission network management scheme according to claim 14, wherein the number of paths which are interrupted is used for calculating said fault influence degree.

16. The transmission network management scheme according to claim 14, wherein the number of interrupted paths weighted according to their preference degrees is used for calculating said fault influence degree.

17. The transmission network management scheme according to claim 14, wherein said network management system constantly compares a fault influence degree of said working plane with that of said protection plane and when a plane having the minimal fault influence degree differs from a plane applied presently, the plane having the minimal fault influence degree is selected as the plane to be applied.

18. The transmission network management scheme according to claim 12, wherein in case after the applied plane is changed to a suitable plane in the event of occurrence of a fault in said transmission network, a bypass exists which is associated with an interrupted path and does not have an adverse influence upon paths normally passable, the interrupted path is relieved by using said bypass.

19. The transmission network management scheme according to claim 12, wherein in association with paths belonging to said working plane, a protection path to be used in the event of occurrence of a fault of a normally used working path is set in advance, switchover in a unit of path is carried out at the time of occurrence of a fault and, when the result of the switchover is in a status unsuitable for the overall network configuration, switchover in a unit of plane is carried out.

20. The transmission network management scheme according to claim 19, wherein when, in an applied plane, a path exists by which any of said working path and said protection path is interrupted, the overall network configuration is so judged as to be in improper status and switchover in a unit of plane is carried out.
